(19) United States
(12) Patent Application Publication
(10) Pub. No.: US 2003/0046557 A1
(43) Pub. Date: Mar. 6, 2003

(54) Multipurpose networked data communications system and distributed user control interface therefor

(76) Inventors: Keith F. Miller, New York, NY (US); Robert A. Berger, New York, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/236,145

(22) Filed: Sep. 6, 2002

Related U.S. Application Data
(60) Provisional application No. 60/317,788, filed on Sep. 6, 2001.

(51) Int. Cl. H04K 1/00

(52) U.S. Cl. 713/186

(57) ABSTRACT

A multi-purpose networked data communications system and any easy to use distributed user control interface to such networked system. The system allows easy control of computer applications and external connected devices (home security, audio/video, etc.) Simplifying modifications to the operating system eliminate the need to reboot individually networked workstations on user sign-on and sign-off, thus increasing the speed with which users access the system. Such access time is further increased by the inclusion of a finger print reader which performs user log-off and log-on and also performs user authentication, thus eliminating the need to type a user name and password. The system further provides for “roaming profiles” ensuring that users are presented on sign-on with any previously stored customized display settings and preferences. In addition, a touch-screen user interface provides automatic “tiling” of running applications and permits simplified Web browsing based on a hierarchy of user preferences. Such user interface further provides standardized controls and software for translating user control activities to attached devices, and facilitates access to a suit of easy-to-use applications developed to run on the networked operating system. Relatedly, such networked operating system implements routines for simplifying the front-end control of existing programs. In addition, front-end wrappers are employed to change the appearance and functionality of particular software applications, thus making such applications more accessible to novice users while retaining full functionality for the more advanced user. Finally, the networked operating system provides for device conflict management which prioritizes application interrupts in accordance with a pre-defined or historic logic.

### CROSS-REFERENCE TO RELATED APPLICATIONS

This is a non-provisional application claiming the benefit of provisional application ser. No. 60/317,788, entitled “Multipurpose Networked Data Communications System and Distributed User Control Interface Therefor”, filed on Sep. 6, 2001, which is incorporated by reference herein.

### BACKGROUND OF THE INVENTION

This invention relates to a multi-purpose networked data communications system, uses of which include home automation, Internet Protocol (IP) telephony and video conferences, interactive streaming media and other computer applications for use by a selected group of people. More particularly, the present invention relates to an improved, easy to use distributed user control interface to such networked data communications system, particularly suited to a group of people including users with little or no familiarity with computers and windows graphical user interface systems. Among other features, the distributed user control interface advantageously facilitates rapid user “log-on” and “log-off” functions eliminating the need to re-boot individual networked workstations upon a new user signing on. In a preferred embodiment, the distributed user control interface includes a reader and software allowing fingerprint authentication of individual users and roaming profiles associated with same. The user interface further preferably includes touch screen controls permitting multiple devices to be controlled using a uniform set of commands; provides access to a suite of easy-to-use applications developed to run on the networked operating system; permits for automatic tiling of running applications; and facilitates simplified Internet Web browsing among pre-defined categories of Web content selected based on a hierarchy of user preferences and/or the user's preferred Web sites. A further feature of the invention comprises front-end wrappers applied to software applications to change the appearance and functionality of such applications, thus making them more accessible to novice users while retaining full functionality for the more advanced user. According to yet another feature of the invention, an improved network operating system simplifies the front-end control of typical computer applications and devices and further, manages conflicts among applications and devices in accordance with pre-defined or historic logic. The invention also advantageously employs a software algorithm for identifying CDs to be stored and catalogued. Yet another feature of the invention is software which provides functionality for transferring or “flinging” audio and video from the distributed user control interface to external devices connected to the network communications system, such as a home television screen, via control commands as simple as touching a button on the touch screen distributed user control interface or pressing a button on a universal remote controller.

Networked data communications systems exist to perform a variety of useful tasks. A common central feature of such systems is the interface by which users interact with the communications system and which permits users to control and command devices attached to the communications system, such as fax machines, printers, file servers and application servers, from a centralized location, using any of several distributed user control interface clients. Networked communications systems used in homes and other high-tech environments are typically specialized devices providing a single or a related set of functions. For example, home automation systems allow household devices to be controlled and commanded at a central server via any of several distributed user control interfaces on for example, wall-mounted panels, hand held remote controls or the like. Similarly, existing video conferencing systems and IP telephony systems employ control and command devices and associated user interfaces, at several diverse locations, to allow users to communicate and to perform other functions, such as, for example, adjusting cameras, broadcasting data files, and controlling data communications. Often these applications require dedicated computer hardware devices and a broad band data communications channel connection to a network services provider.

User interfaces, such as computer workstations, that allow remote control of centralized computer applications running on a server associated with a networked data communications system typically contain a wide range of complexity and are geared toward users familiar with the operation of computers in general, and Windows graphical user interfaces in particular. As such, these systems often require training of the operator. Unfortunately, in many environments, and particularly in residential settings, such complexity makes it difficult for novice users to take full advantage of the functionality of the user interface and may discourage use of the system altogether.

Another drawback associated with traditional networked data communications systems is that “log-on” and “log-off” features, that is, the programming and data entry associated with allowing different users to gain access to and exit the system, generally require that the user wait for a considerable period of time while the workstation logs out a current user, typically by shutting down, to some extent, the operating system, and re-launching the operating system, and then executing a log-on procedure for the new user. Such delay is unacceptable when the user is attempting to access certain high priority control systems such as home lighting or security systems and, as a result, such systems may not include user personalization capabilities. Further adding to the delay and complexity in accessing traditional networked data communications systems is the need for users to remember and enter passwords associated with user accounts.

The present invention also relates particularly to home networking control applications. The fast pace of technology makes any definition of home networking a moving target. However, the Home Networking Council of the trade organization CEDIA (Custom Electronic Design and Installation Association) has defined it as follows: “Home Networking is the technology that allows all electronic devices in the user's environment to seamlessly communicate with each other and the outside world. A home network interconnects electronic products and enables remote access to and control of the products and any available content such as music, video, and data.”

Professional home integrators, such as those who belong to CEDIA, have for many years designed and installed elaborate, customized home networks that integrate lighting, HVAC (Heating, Ventilation and Air Conditioning), security, and entertainment controls. Such systems are costly to implement and maintain, and typically require the user or installer to cobble together diverse system components. Because of the diversity, control of the individual components varies widely and is not generally intuitive. This creates a barrier to a user that wishes to take advantage of all of the system's features particularly when attempting to use a single remote control interface device. In fact, even devices with similar or related functions such as home theatre/audio-video systems, can provide challenges to the user's interaction when a single, universal remote control interface device is used.

Today, many more homeowners are already implementing simple home networking of computer applications by linking multiple PCs, or sharing a broadband Internet connection. Additionally, modern home entertainment systems which also may be installed throughout the home and which may be connected to the Internet, permit many advanced features made possible by such networked data communications systems, including, for example, viewing on-demand movies through set-top cable boxes and satellite receivers.

Growing ranks of network-capable products are easing the technical challenges in building comprehensive home networks in the CEDIA fashion. This growth, however, has exposed a previously ignored larger issue: the user experience. The complexity of the modern home network, due to the varying interfaces among disparate components, may keep a user from realizing the tangible lifestyle benefits such as convenience, productivity, comfort, and security of such systems.

Accordingly, there is a need for a networked data communications system and home networking system that are controlled and commanded via an easy-to-use distributed user control interface, allowing users unfamiliar with computers and Windowing graphical user interfaces to rapidly and intuitively select a desired function or enter a desired command. The distributed user control interface permits the user to easily run applications and control devices attached to the data communications system because standardized controls are used and software is provided for translating the control activities of the user to the network applications and attached devices.

There is a related need for such an interface which provides for rapid sign-on, sign-off and authentication of individual users accessing the system; and which facilitates browsing of the Internet and easy storage and automatic categorization and archiving of information; and which permits multiple applications and devices to be controlled using a uniform set of commands; and which facilitates the transfer or “flinging” of audio and video from the distributed user control interface to external device connected to the network communications system. In connection with the foregoing, there is also the need to provide an improved network operating system which simplifies the control of pre-existing computer applications and multiple devices and further, manages conflicts among such applications and devices in accordance with pre-defined logic.

### SUMMARY OF THE INVENTION

It is an object of the invention to meet the present needs and objects and to overcome the above-described shortcomings of conventional networked data communications systems and their remote control user interfaces.

Thus, a networked data communications system and a distributed user control interface comprising the elements and features described herein is provided.

According to one feature of the invention, the system provides for rapid access to individual user accounts by eliminating the need to restart the operating system or a portion thereof and run a profile manager each time a user logs on or off a networked workstation or other remote control devices. Such processing is facilitated by another feature of the invention, namely, simplifying modifications made to the networking computer operating system employed by the invention.

According to another feature of the invention, the foregoing user sign-on procedure is integrated with a fingerprint reader which through a link to software operating on the system performs log off for the current user and logon for the new user, and further, performs user authentication, thus eliminating the traditional need to remember and type an account name and password. By virtue of these features, user access is accomplished rapidly and with a minimum of complexity.

More specifically, the user interface employs a generic-user logon applicable to a work group (or, family) with access or “sub-logins” for individual users in the work group or family effectuated by touching the button on the touch sensitive user interface display associated with the fingerprint reader in the preferred embodiment. This “sub-login” procedure further advantageously provides for “roaming profiles” (profiles stored on a centralized server and available when a user logs onto any distributed user control interface device on the network), ensuring that upon sign-on, users are presented upon sign-on with any previously stored customized display settings and preferences.

According to yet another feature of the invention, a touch-screen user interface comprises a number of user-friendly and intuitive features. One such feature is the automatic “tiling” of running applications, serving both to maximize use of the entire display screen, and to allow users unfamiliar with the operation of computers and windowing systems to access and use multiple applications at once with little or no training. Standardized user activated touch controls are advantageously provided on the touch screen for controlling computer applications running on, and external devices attached to, the networked communications system.

Another user-friendly feature of the touch-screen user interface is that it provides for simplified Web browsing, particularly when browsing among pre-defined categories of Web content. Such browsing is implemented by customizing user account profiles providing for the display of a list of topic categories selected based on a hierarchy of user preferences. Users need only touch a button-like control shape on the touch screen associated with a particular enumerated category to display a URL of interest, and this procedure may be repeated, for example, in a preferred embodiment, up to three times or more, to cycle through, in this example, three or more separate URLs. URL results may either be discarded or book-marked [archived] into the presently selected category or into subcategories, based on the current category viewed, for future access. Such easy to navigate features ensure that novice computer users will have no problems gaining access to and storing information of interest available on the Internet.

The user interface further provides for touch-screen access to a suite of easy-to-use computer applications specially developed to run on the networking operating system employed by the invention. Relatedly, such networked operating system implements routines and displays standardized control elements for simplifying the front-end control of computer applications and devices.

According to still another feature of the invention, “functionality skins” (simplified front-end wrappers used to change the appearance and functionality of particular software applications) enable users to quickly and easily learn how to operate and access the functionality of those software applications. Such functionality skins make applications more accessible to novice users by grouping related commands into a common standard interface. For example, a preferred implementation applies functionality skins to simplify the Microsoft Office title bar, menu structure and button bars to present the end user with only the most basic and often used commands. Typically, a user-activated area on the screen also allows control of the software by the software's built in controls, and thus experienced users also have access to the full wealth of functions available.

According to yet another feature of the invention, a software recognition algorithm is advantageously employed to identify CDs before storing and cataloging them as MP3 audio tracks. Such algorithm improves upon prior art as it allows a greater number of CDs to be successfully recognized, particularly when track length information may vary among pressings.

Another feature of the invention is software which provides for the transfer or “flinging” of audio and video from the distributed user control interface to external devices connected to the network communications system, such as larger stand-alone television screens or high-definition video monitor or plasma displays. Such flinging of media content is accomplished via simple control commands which may include, for example: touching a button on, or swiping a finger across, the touch screen user interface; dragging an icon across the user interface using a conventional computer mouse; or pressing a button on a universal remote controller. Other suitable control means will be readily apparent to those of ordinary skill in the art. For example, in an embodiment of the invention which replaces the touch screen user interface with a personal digital assistant, “flinging” may be accomplished by selecting the appropriate menu command using a stylus and location sensitive touch screen of the PDA. The ability to “fling” content allows full use to be made of existing home electronics devices and enhances the user's interaction with the system. For instance, with the touch of a button a user may transfer a streaming DVD feed from the distributed user control interface to a large screen television where it may be viewed by others in the room.

According to still yet another feature of the invention, the employed network operating system provides for device and service conflict management which prioritizes application interrupts in accordance with a pre-defined or historic logic. Such prioritization is accomplished by querying the user, or by following a pre-defined heuristic. For example, as applied to a home automation system, such heuristic may interrupt an application providing DVD audio feed in favor of an application providing a front door close captioned TV feed when the front door buzzer is activated.

Still other features, objects and advantages of the invention will in part be obvious and will in part be apparent from the specification and drawings.

The invention accordingly comprises the several steps and the relation of one or more of such steps with respect to each of the others, and the apparatus embodying features of construction, combination of elements and arrangement of parts which are adapted to effect such steps, all as exemplified in the following detailed disclosure.

### BRIEF DESCRIPTION OF THE DRAWINGS

For a fuller understanding of the invention, reference is had to the following description taken in connection with the accompanying figures, wherein like reference numbers refer to like components among the drawings:

FIG. 1 depicts a front, side and top perspective view of a touch screen, pedestal base and wireless keyboard of an embodiment of the invention;

FIG. 2 depicts a back, side and top perspective view of a touch screen, pedestal base and wireless keyboard of the embodiment shown in FIG. 1;

FIG. 3 depicts a schematic representation depicting the visual display of a touch screen associated with a distributed user control interface device showing a logon screen display of an embodiment of the invention;

FIG. 4 depicts a schematic representation depicting the visual display of a touch screen showing a logon screen display and logon information of a user of the embodiment shown in FIG. 3;

FIG. 5 depicts a schematic representation depicting the visual display of a touch screen associated with a distributed user control interface device showing a typical initial device launch screen display of an embodiment of the invention;

FIG. 6 depicts a schematic representation depicting the visual display of a touch screen associated with a distributed user control interface device showing a typical initial technical support screen display of the embodiment shown in FIG. 5;

FIG. 7 depicts a schematic representation depicting the visual display of a touch screen associated with a distributed user control interface device showing a typical door answering screen display of the embodiment shown in FIG. 5;

FIG. 8 depicts a schematic representation depicting the visual display of a touch screen associated with a distributed user control interface device showing a typical video calling screen display of the embodiment shown in FIG. 5;

FIG. 9 depicts a schematic representation depicting the visual display of a touch screen associated with a distributed user control interface device showing a typical surveillance screen display of the embodiment shown in FIG. 5;

FIG. 10 depicts a schematic representation depicting the visual display of a touch screen associated with a distributed user control interface device showing a typical voice over IP telephony screen display of the embodiment shown in FIG. 5;

FIG. 11 depicts a schematic representation depicting the visual display of a touch screen associated with a distributed user control interface device showing a typical Internet browser screen display of the embodiment shown in FIG. 5;

FIG. 12 depicts a schematic representation depicting the visual display of a touch screen associated with a distributed user control interface device showing a typical multimedia submenu screen display of the embodiment shown in FIG. 5;

FIG. 13 depicts a schematic representation depicting the visual display of a touch screen associated with a distributed user control interface device showing a typical CD library screen display accessed from the multimedia submenu screen display of the embodiment shown in FIG. 12;

FIG. 14 depicts a schematic representation depicting the visual display of a touch screen associated with a distributed user control interface device showing a typical Internet radio screen display accessed from the multimedia submenu screen display of the embodiment shown in FIG. 12;

FIG. 15 depicts a schematic representation depicting the visual display of a touch screen associated with a distributed user control interface device showing a typical television screen display accessed from the multimedia submenu screen display of the embodiment shown in FIG. 12;

FIG. 16 depicts a schematic representation depicting the visual display of a touch screen associated with a distributed user control interface device showing a typical DVD screen display accessed from the multimedia submenu screen display of the embodiment shown in FIG. 12;

FIG. 17 depicts a schematic representation depicting the visual display of a touch screen associated with a distributed user control interface device showing a typical home automation environmental control screen display of the embodiment shown in FIG. 5;

FIG. 18 depicts a schematic representation depicting the visual display of a touch screen associated with a distributed user control interface device showing a typical user application launch screen display of the embodiment shown in FIG. 5;

FIG. 19 depicts a schematic representation depicting the visual display of a touch screen associated with a distributed user control interface device showing a typical e-mail application window on the user application launch screen display of the embodiment shown in FIG. 18;

FIG. 20 is schematic representation depicting the visual display of a touch screen associated with a distributed user control interface device showing a typical computer application launch screen display on the user application launch screen display of the embodiment shown in FIG. 19;

FIG. 21 depicts a schematic representation depicting the visual display of a touch screen associated with a distributed user control interface device showing a typical word-processing application window display on the user application launch screen display of the embodiment shown in FIG. 19;

FIG. 22 depicts a schematic representation depicting the visual display of a touch screen associated with a distributed user control interface device showing a typical word-processing application in a full window display of the embodiment shown in FIG. 5;

FIG. 23 depicts a schematic representation depicting the visual display of a touch screen associated with a distributed user control interface device showing a typical Internet browsing application window display on the user application launch screen display of the embodiment shown in FIG. 19;

FIG. 24 depicts a schematic representation depicting the visual display of a touch screen associated with a distributed user control interface device showing a typical Internet browsing application in a full window display of the embodiment shown in FIG. 5;

FIG. 25 depicts a schematic representation depicting the visual display of a touch screen associated with a distributed user control interface device showing a typical door answering application window display of the embodiment shown in FIG. 23;

FIG. 26 depicts a schematic representation depicting the visual display of a touch screen associated with a distributed user control interface device showing a typical quick menu window display of the embodiment shown in FIG. 23;

FIG. 27 depicts a schematic representation depicting the visual display of a touch screen associated with a distributed user control interface device showing a typical voice over IP telephone application window display of the embodiment shown in FIG. 26;

FIG. 28 depicts a schematic representation depicting the visual display of a touch screen associated with a distributed user control interface device showing a typical multimedia submenu window display of the quick menu window display of the embodiment shown in FIG. 26; and

FIG. 29 depicts a schematic representation depicting the visual display of a touch screen associated with a distributed user control interface device showing a typical CD library application window display of the multimedia submenu window display of the embodiment shown in FIG. 28.

### DETAILED DESCRIPTION OF THE PREFERRED EMBODIMENTS

In order to best appreciate the full scope of the present invention, when describing preferred embodiments certain basic abstractions are made with respect to commonly known components and features in order to simplify the presentation and highlight the novel aspects of the multipurpose networked data communications system and the distributed user control interface used to control it. For example, a typical user's interaction with the system through use of the distributed user control interface will be described. Although this embodiment is described as primarily using a touch sensitive liquid crystal display panel for recording locations of a user's touch corresponding to particular iconic representations of buttons displayed thereon, it will be apparent to those of ordinary skill and the art that conventional computing user interfaces may be used as well as any other common control devices that can exchange data with the networked system. For example, a common cathode ray tube display and a mouse or other pointing device, can be used in conjunction with software displaying a user interface comprising user activatable areas and data presentation areas. Common examples include the Windows operating system and any of the myriad programs designed to run on it. In another embodiment that would be easy to construct, a small text based display, such as those found on cellular phones and personal digital assistants, may be used to present controls and data to the user. In the first instance, reference numerals associated with command controls, corresponding to the number keypad of a telephone, are used to interact with the data communications system; and in the second instance, the user can use the stylus and location sensitive touch screen of the PDA device.

In a preferred embodiment, a touch sensitive liquid crystal screen displaying user activatable areas and a graphical images of controls corresponding to functions to be performed by the data communications system and software is used. The interface will be large enough and sharp enough to easily permit viewing of up to four different applications at any time. For example, an 18.1 inch screen (measured between diagonal corners) displaying 1280 horizontal pixels and 1024 vertical pixels may be used. Such a screen may be broken down into four equal quadrants of 640 horizontal pixels by 480 vertical pixels, when, for example, four applications are being viewed.

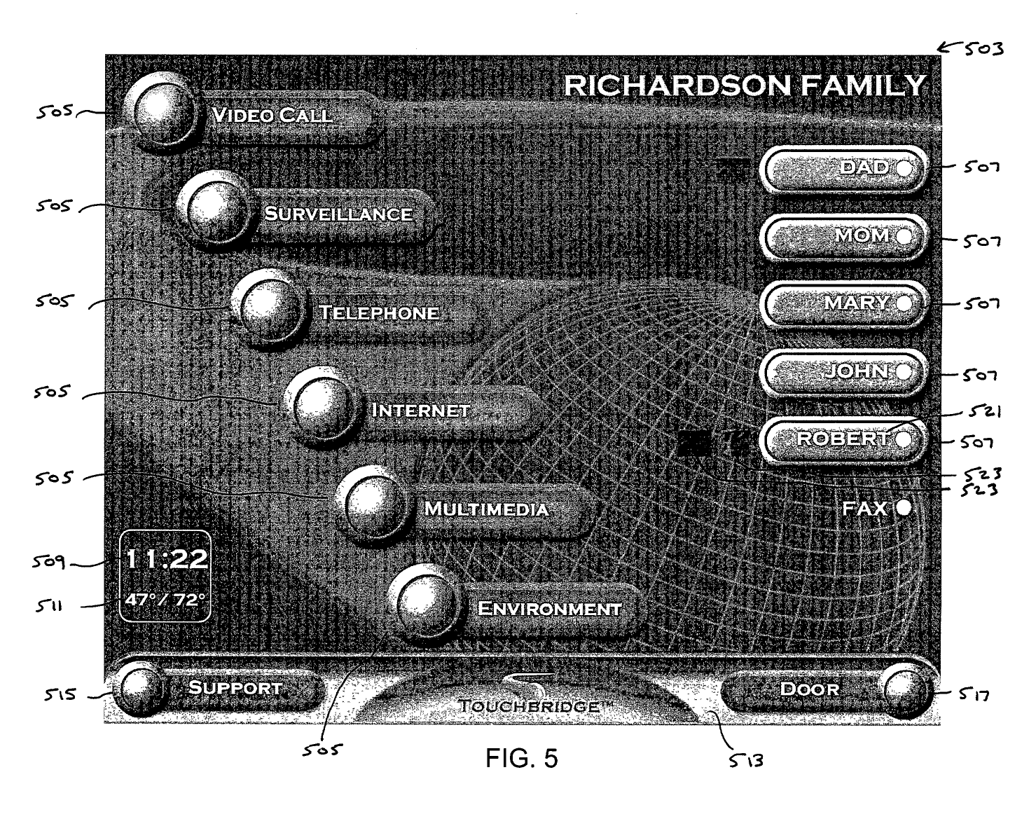

A typical scenario is described in order to provide an overview of the many functions and features of the data communications system and the distributed user control interface. The user is greeted by a main screen image on the distributed user control interface comprising button shaped graphics associated with the main applications that are offered. See generally FIG. 5, discussed further below.

Once one application is accessed, typically by the user physically touching a touch sensitive screen on the button location associated with it, the viewable screen changes to the application selected in full screen mode. Should the user desire to access any of the other main applications, they will have access through a menu area located at the bottom of the screen. This menu area, which is generally always available, allows quick access to any of the main applications, and thus may be termed the quick access menu.

The quick access menu typically occupies the entire width of the screen and approximately 10% of the height. Within this portion of the screen, typically two application start buttons may be continuously displayed. As these buttons are nearly always seen on the screen, the applications assigned to them will be applications which are most useful to the user. Typically, for instance, the buttons will include a front door answer and intercom application and a technical support application.

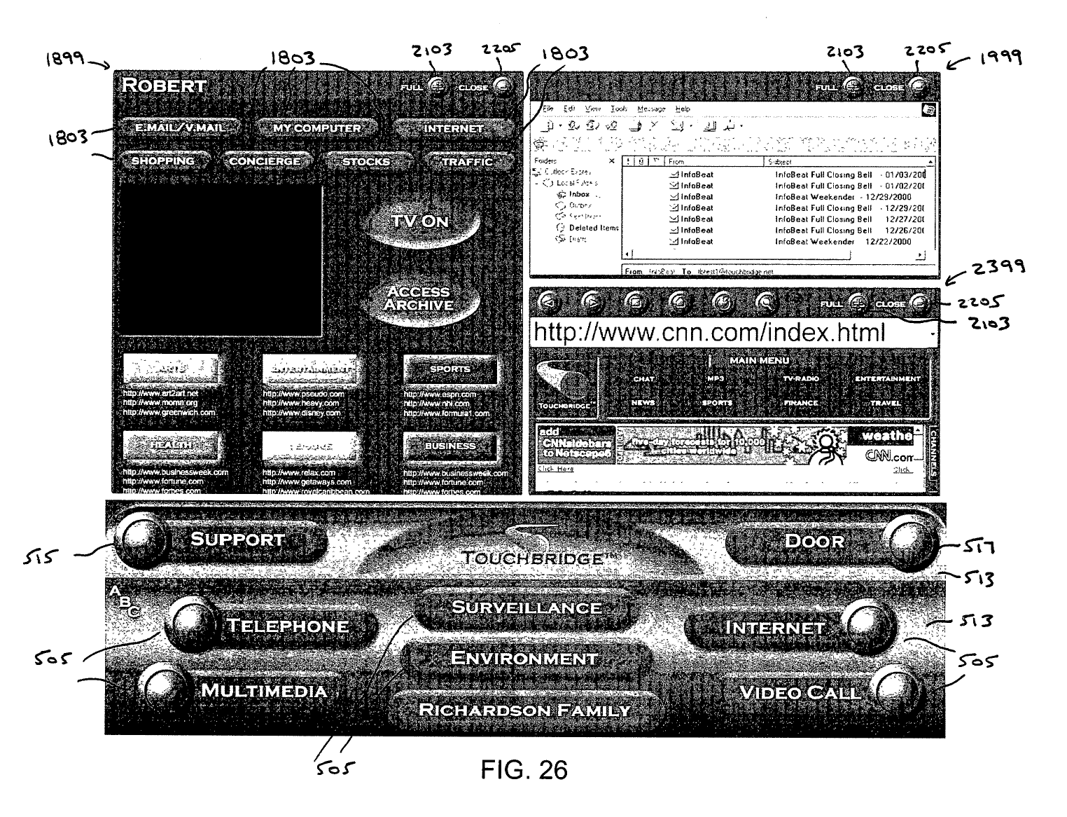

Typically, in between these two application start buttons will be provided a control area for expanding the quick access menu for allowing quick access to several other application start buttons. When the control area is pressed, the quick access sub-menu raises and takes up approximately 33% of the viewable screen with immediate access to all features either directly from application start buttons or by individual menu control buttons toggling to groups of other applications in sub menus, in a typical hierarchical menuing system. See generally FIG. 26, discussed further below.

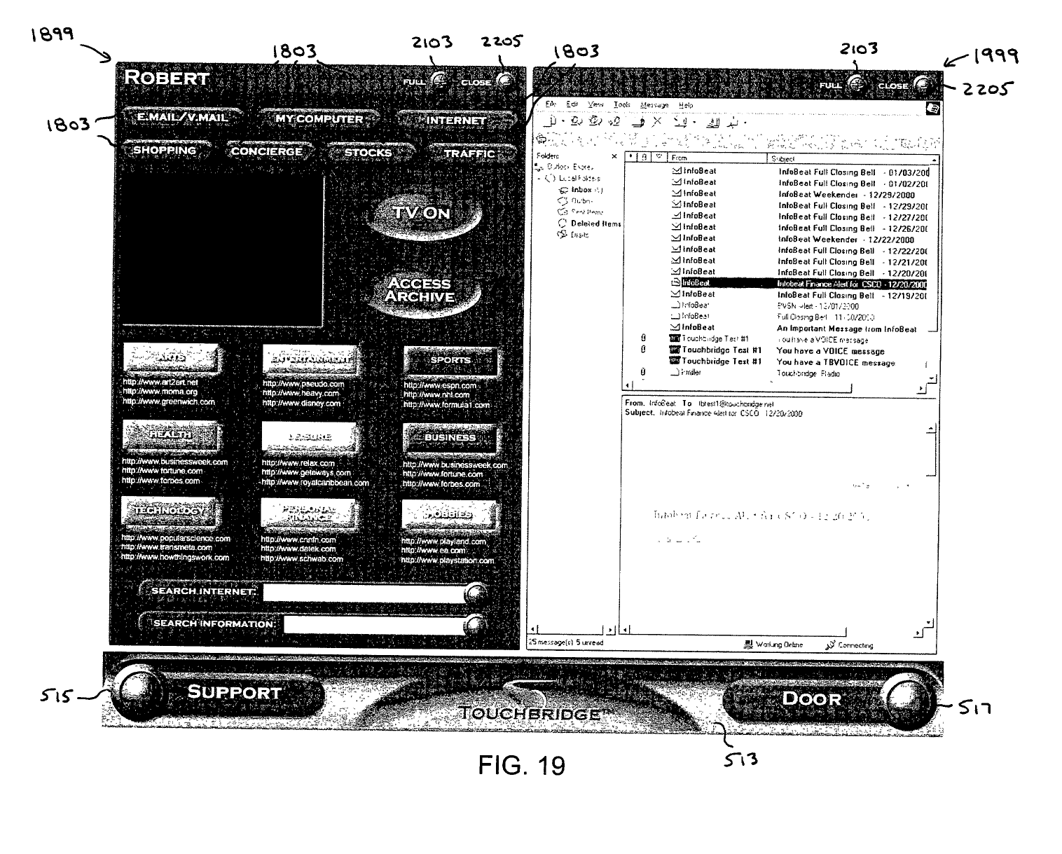

Once another application is accessed, the initial application shifts over to the left half of the screen, for example, and then the newly selected application is viewable through a split screen (Vertically) occupying the right half of the screen. The quick access menu then restores itself (moves down) to its original positioning. See generally, FIG. 19 discussed further below.

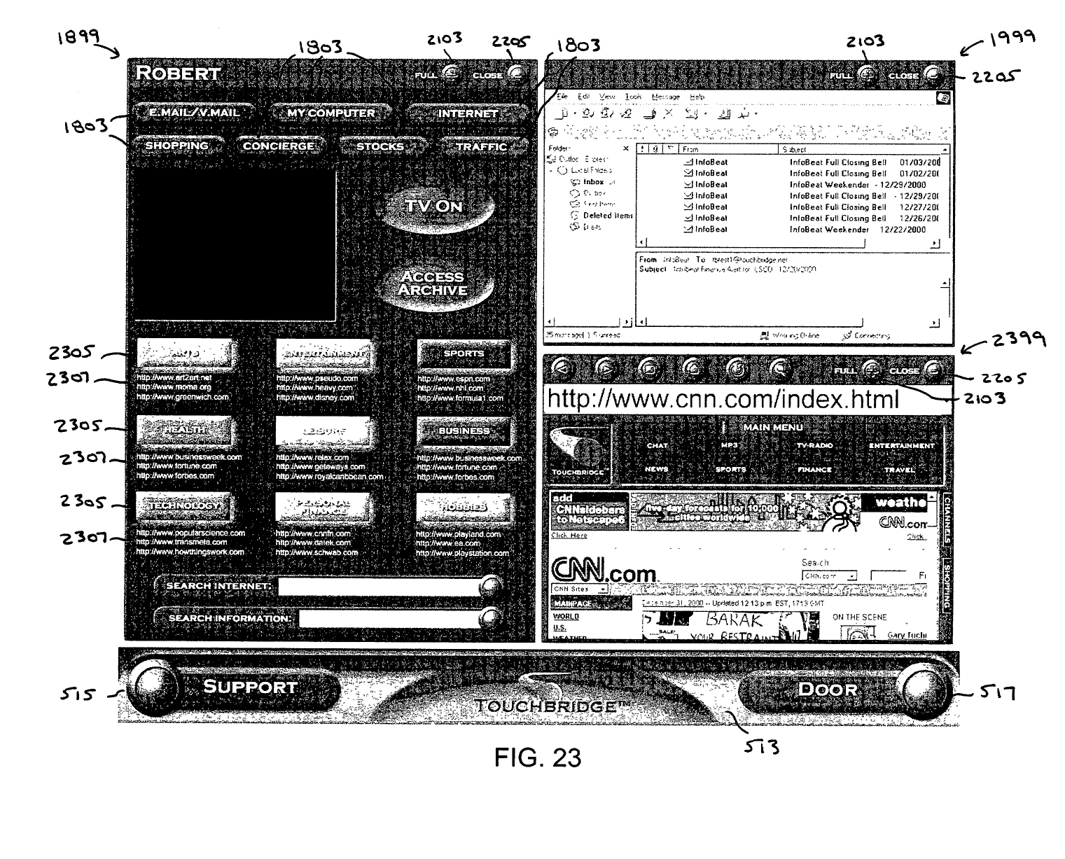

If the user desires to select a third application, the user raises the quick access menu again by activating the control buttons to be offered the main applications to choose from. Upon the user selecting another application, the two active applications shift to accommodate the third. In this case, the most recently selected application will commonly comprise the an entire half of the screen, split vertically, while the first two applications running will comprise the other half of the screen split horizontally to accommodate the two applications; one on top of the other. See generally FIG. 23 discussed further below.

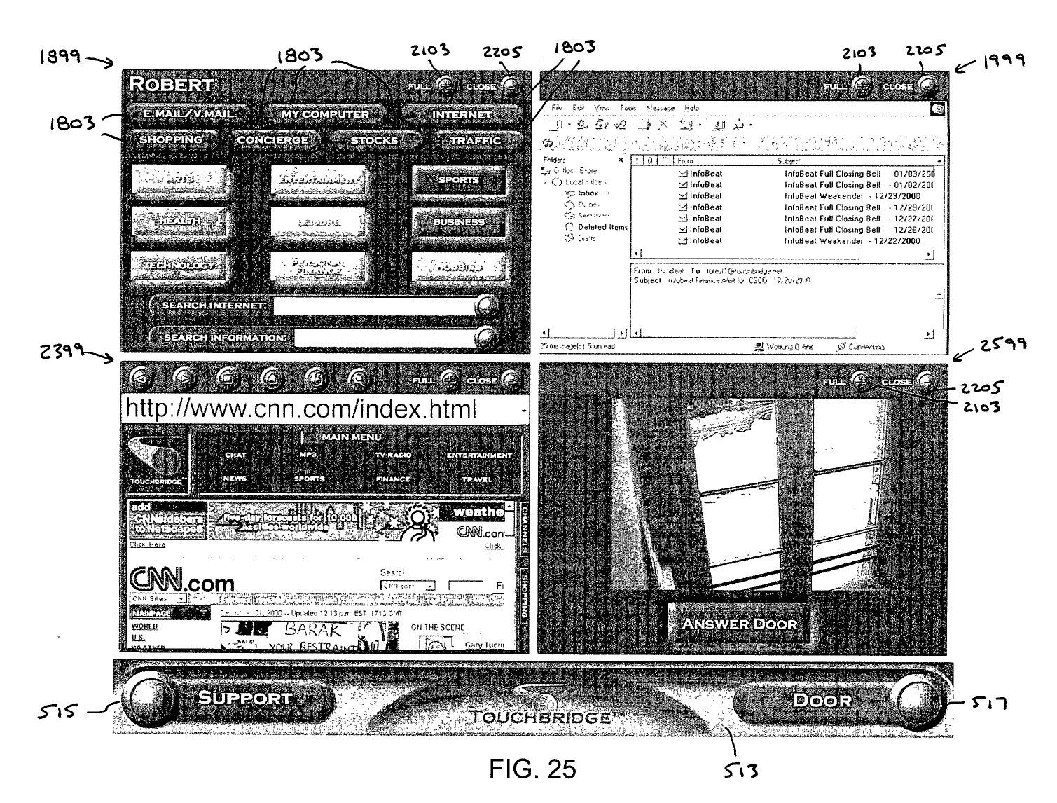

If the user desires to view a fourth additional application, they again select the control buttons to raise the quick access menu and access the application start button. Once the quick access menu drops down and is restored, the user views all four applications; each one in an equal quadrant. See generally, FIG. 25 discussed further below.

Upon closing out an application, through an easy to access and standardized “Close” button area on the upper right hand corner portion of the display area for each application, the screen will revert to the three active application configuration. The network operating system advantageously provides these button areas when displaying the applications and links their activation to the “close application” command for that application.

If the user instead prefers to view any application in full screen mode while multiple applications are being viewed, they press a “full” control button area which may be added by the operating system in the upper right corner portion of each application. This will effectively cover all the other applications with the one selected to be full screen. Any application that is full screen no longer has a “Full” button control portion in the upper right corner. Instead, this portion of the screen may contain a “Back” button control portion, which when activated, restores the screen to the prior multi-application display mode.

Once the user selects to close an application from the three-application screen, the viewer will see the two-application screen, split in half, as previously described. Closing one application of the two will revert to the one application taking up the full screen.

In order to best realize the data communications system and distributed user control interface of the present invention, a preferred embodiment comprises the following hardware and software components:

Hardware Typically Includes:

1. Flat-panel display screens with touch-sensitive technology and fingerprint-resistant glass

2. Built-in echo and noise canceling microphone array

3. Built-in camera with positioning mechanism

4. Built-in biometric device (thumbprint reader) for gaining access to personal features and information

5. Touch screen docking mechanism allows mounting screen panel on stand or on a wall or other flat surface

6. Built-in speakers and mini-subwoofer

7. Built in infra-red receiver for communicating with a wireless keyboard/mouse device.

8. Personal Tower PC provides local functionality and connects to the Main Server

9. Main Server (enterprise-strength, 110 GB hard drive usable capacity)

10. Router

11. Symmetrical DSL or other high-bandwidth connection to an Internet service provider that provides fixed publicly addressable IP addresses

12. High speed Ethernet switch

13. Camera server

Software Typically Includes:

1. integration software built on Microsoft Windows® 2000 platform

2. “one-button” back-up and recovery features

3. Simultaneous multiple users on one system

4. On-screen multitasking capability

5. Automatic software upgrade capability

6. Individual and family personalization of data and screens

7. Limited (or no) access to those not authorized

8. Access from external terminals—office PCs, PDAs, etc.—via password protected network protocols

9. Dynamically learns your customized Internet Web surfing patterns

10. Allows “flinging” items from touch screen display to larger, stand-alone video screens (plasma screen, etc.), while recovering primary screen real estate from “flung” item for use by other applications

11. Auto-detection and adaptation to native resolution of application to stand-alone video screen

12. Full on-screen capability for video sources (DVD, VHS, DSS, cable, broadcast TV, etc.)

13. Telephony—High-quality Internet telephone (VoIP)

14. Full video conferencing capability

15. Home security and home automation control systems interface

16. Included services from a service provider include Internet radio

17. Premium (subscription) services include: real-time traffic views, personal concierge, e-commerce, commercial-free Internet radio, etc.

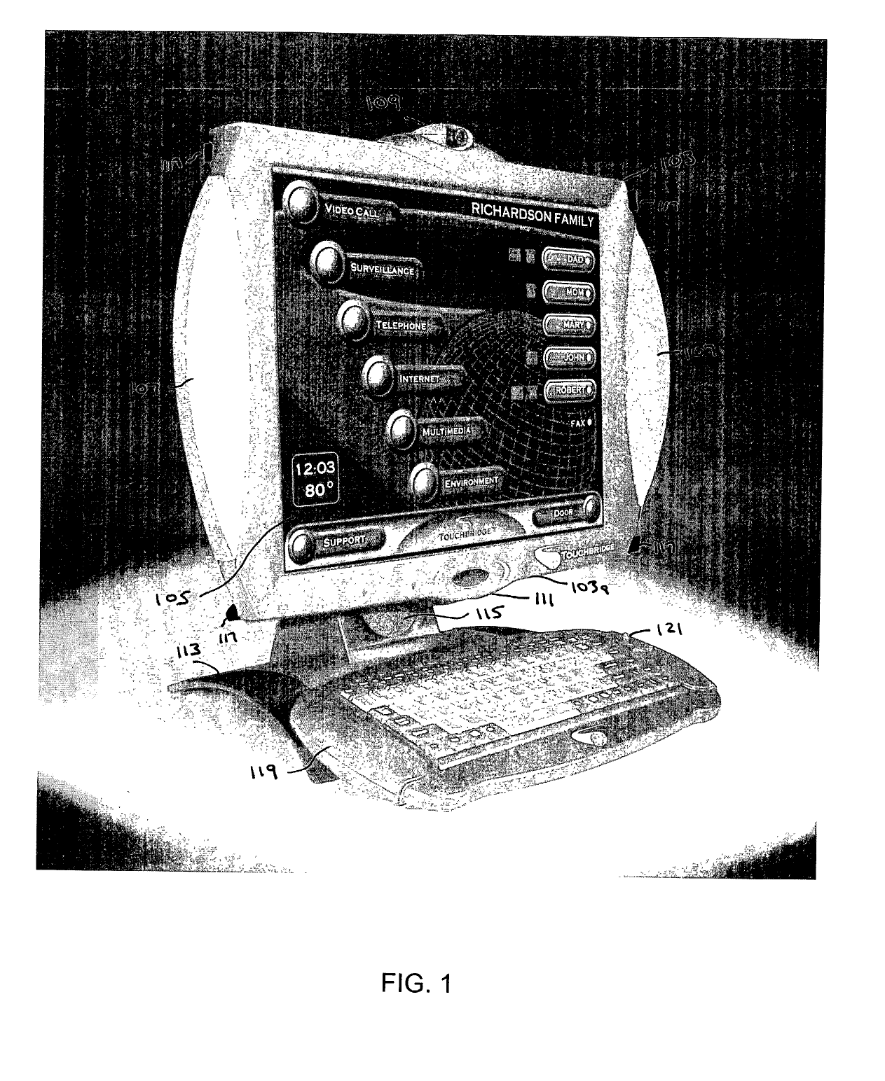

The present invention can now be described in more detail with respect to a user's interaction with such hardware and software components previously described. FIG. 1 depicts a front, side and top perspective view of a touch screen, pedestal base and wireless keyboard of an embodiment of the invention. Not shown in this figure is a personal computer workstation, as further described herein.

FIG. 1 shows a distributed user control interface touch screen, generally at 103 including a flat panel display portion 105, stereo speakers 107, a video camera 109 and a fingerprint reader 111. The fingerprint reader 111 is located in the center of the underside of the screen bezel 103a. To use the reader, an individual would reach under the screen and place his or her finger up against the lower portion of the screen bezel 103a and press upwards. Of course, other locations and types of fingerprint readers may be used with the present invention while maintaining the spirit and scope of the present invention.

While touch screen 103 is shown as an integral unit with speakers 107, video camera 109 and finger print reader 111, it will be readily understood by those of ordinary skill in the art that similar functionality can be provided by conventional separate components. Additionally, while touch screen 103 includes a flat panel display 105, an ordinary cathode ray tube display unit may also be used. Similarly, separate stand alone speakers 107 can be mounted anywhere near the display, or need not be included at all.

As shown in FIG. 1, touch screen 103 is mounted on a pedestal base 113. In a preferred embodiment, touch screen 103 may be removed from pedestal base 113 and mounted on a wall, for example. Pedestal base 113 may also include a subwoofer speaker 115, which in conjunction with speakers 107, provide a rich stereophonic audio experience.

In a preferred embodiment, touch screen 103 may also include up to four or more independent microphones 117 forming a microphone array. Digital array microphones 117 are coupled with software which is known in the art which determines minor differences in the distance of each audio source from each microphone in order to approximate a positioning of the audio source. Software additionally coupled to video camera 109 can move and point video camera 109 to such source. In this way, a person who may be speaking as part of a video conference, will automatically become the subject of the frame of video camera 109. Digital array microphones 117 provide additional conventional benefits, such as noise canceling, which thus enables the audio source, particularly the spoken word, to be used in voice recognition applications and the like, as is well known. Additionally, the digital array microphones 117 provide for an input from the audio source powering the speakers 107 and subwoofer 115, so as to be able to prevent sound from the speakers 107 and subwoofer 115 from looping into the microphone, thereby avoiding loud unwanted squealing sounds, known in the art as looped feedback.

FIG. 1 also shows a keyboard 119 which includes conventional alphanumeric keys as well as computer control keys. In the preferred embodiment shown in FIG. 1, keyboard 119 is a wireless keyboard and communicates with the personal computer network client via infrared or radio wave communications as known by those of ordinary skill in the art. In a preferred embodiment, wireless keyboard 119 will also include a joystick-like control device 121 which functions like a joystick or a conventional computer mouse or track ball when coupled with appropriate software, as is well known by those of ordinary skill in the art.

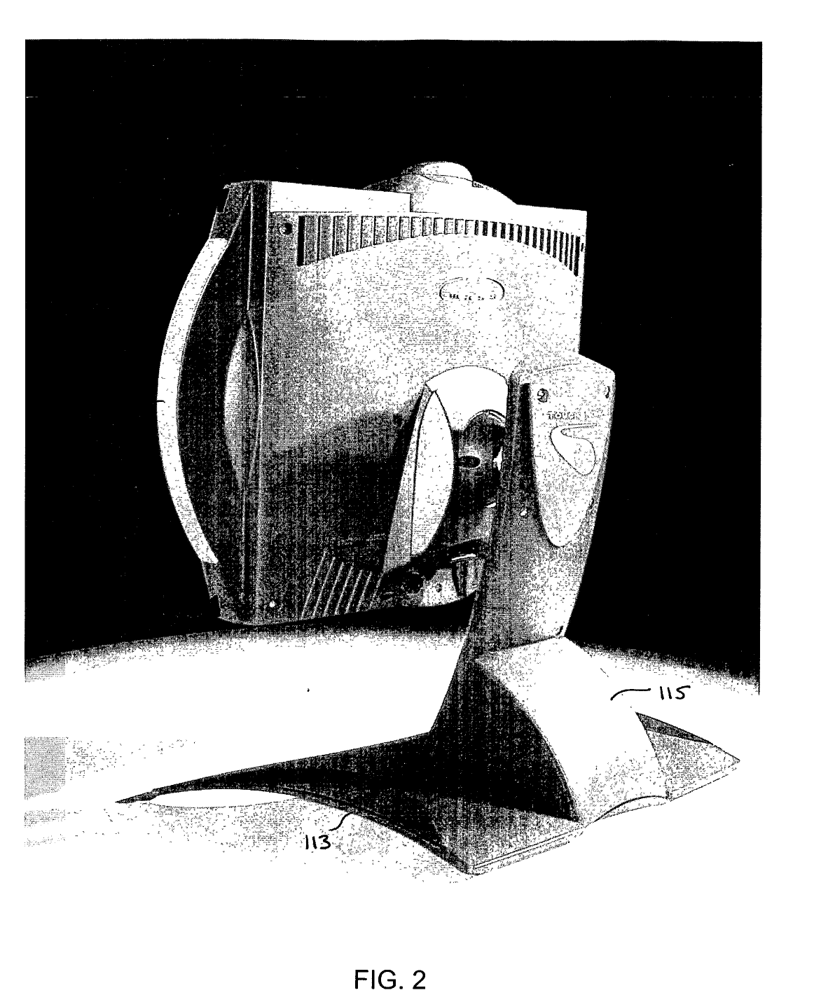

FIG. 2 depicts a back, side and top perspective view of a touch screen, pedestal base and wireless keyboard of the embodiment shown in FIG. 1. FIG. 2 also shows touch screen 103, right speaker 107, video camera 109, pedestal base 113, sub woofer 115, and two microphones of microphone array 117.

The usefulness of the invention will best be illustrated by a more detailed description of a typical users' experience when using the networking hardware and software of the present communications system invention.

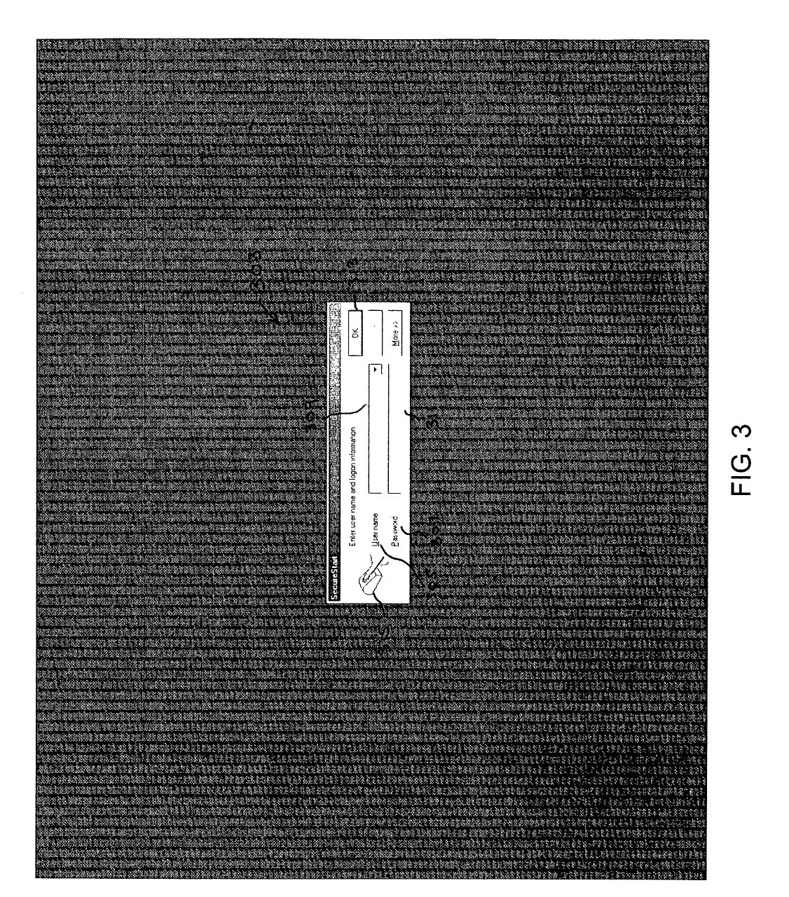

FIG. 3 depicts a schematic representation depicting the visual display of a touch screen associated with a distributed control user interface device showing a logon screen display of an embodiment of the invention. FIG. 3 shows a secure log on screen as displayed on flat panel 105 on touch screen 103 when the hardware and software is initially started. A small logon dialog box 303 prompts a user for his or her user name 305 and password 307. A user name drop down list or combo box 309 may allow a user to select from available user names (not shown).

A password text input box 311 allows the user to enter a password by conventional typing on keyboard 119. A logon command button 313, when activated, executes a software procedure for transferring the information contained in drop down list or combo box 309 and text box 311 to the network server (not shown). A fingerprint logon icon 315 depicts providing a fingerprint to fingerprint reader 111 as an alternative means of logging on.

In this case, a user may choose to provide his or her fingerprint against fingerprint reader 111 in FIG. 1 rather than entering information such as their user name in user name drop down list or combo box 309 and typing in their password in password text input box 311.

In the case where the system is already running, this screen may be recalled whenever a new user is to logon, or, for instance, by activating a control associated with a particular user, namely, that user's personalized page icon 507. In this case, drop down list or combo box 309 may be pre-filled with the correct user's name.

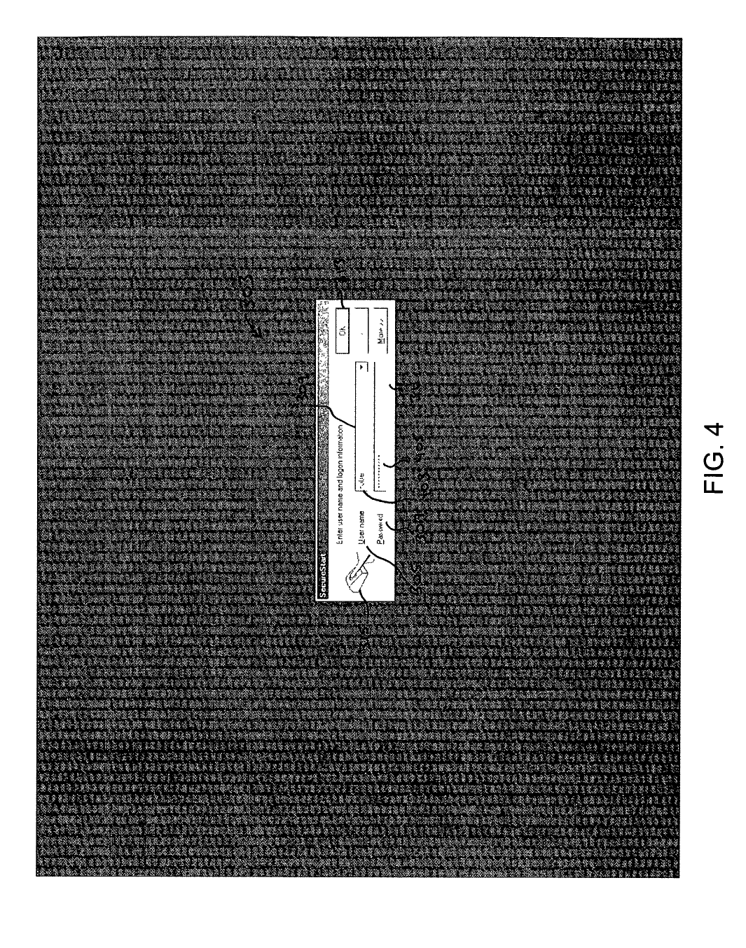

FIG. 4 depicts a schematic representation depicting the visual display of a touch screen showing a logon screen and logon information of a user of the embodiment shown in FIG. 3 having information filled in user name drop down list or combo box 309 and password text input box 311, namely as shown, a user's name (Robert) 403 and that user's password (*****) 405, which is shown as asterisks for security, as is well known in the art.

The filled in log on dialog box 303 shown in FIG. 4 may also be the result of that user pressing his or her fingerprint against fingerprint reader 111 in FIG. 1 and the software making a match with that fingerprint for providing user's name (Robert) 403 and user's password (*****) 405.

Alternatively, the filled in logon box 303 shown in FIG. 4 may be the result of that user selecting their personal button from the list of buttons displayed on the right side of FIG. 1, and then pressing his or her fingerprint against fingerprint reader 111 in FIG. 1.

Once information is filled in to log on dialog box 303, the user presses logon command button 313 and the software determines if user's name (Robert) 403 and user's password (*****) 405 match an authorized user of the system. Information about authorized users can be kept in a secure data table or other databases, as is well known in the art.

Alternatively, upon identifying a fingerprint pressed against finger print reader 111 in FIG. 1, and determining the user name and password as previously described, the software can automatically look to match and authenticate that user without that user having to press logon command button 313.

User sign-on and sign-off is accomplished by software for directly editing user profile information stored in the operating system registry keys, reconfiguring the user profile for the workstation and refreshing the display.

FIG. 5 depicts a schematic representation depicting the visual display of a touch screen associated with a distributed user control interface device showing a typical initial application launch screen display 503 of an embodiment of the invention as displayed on flat panel 105 on touch screen 103, after a user has been authenticated and the initial application launch program is running. Initial application launch screen 503 includes several application launch icons 505 for launching various applications, as well as personalized page icons 507 for entering user personalized areas on the networked communications system. Initial application launch screen 503 may also include information such as a time of day display 509 and an internal and external temperature gauge display 511. A quick menu portion 513 of initial application launch screen 503 includes technical support application launch icon 515 for contacting technical support and a front door control application launch icon 517 for controlling a front door intercom and answering application.

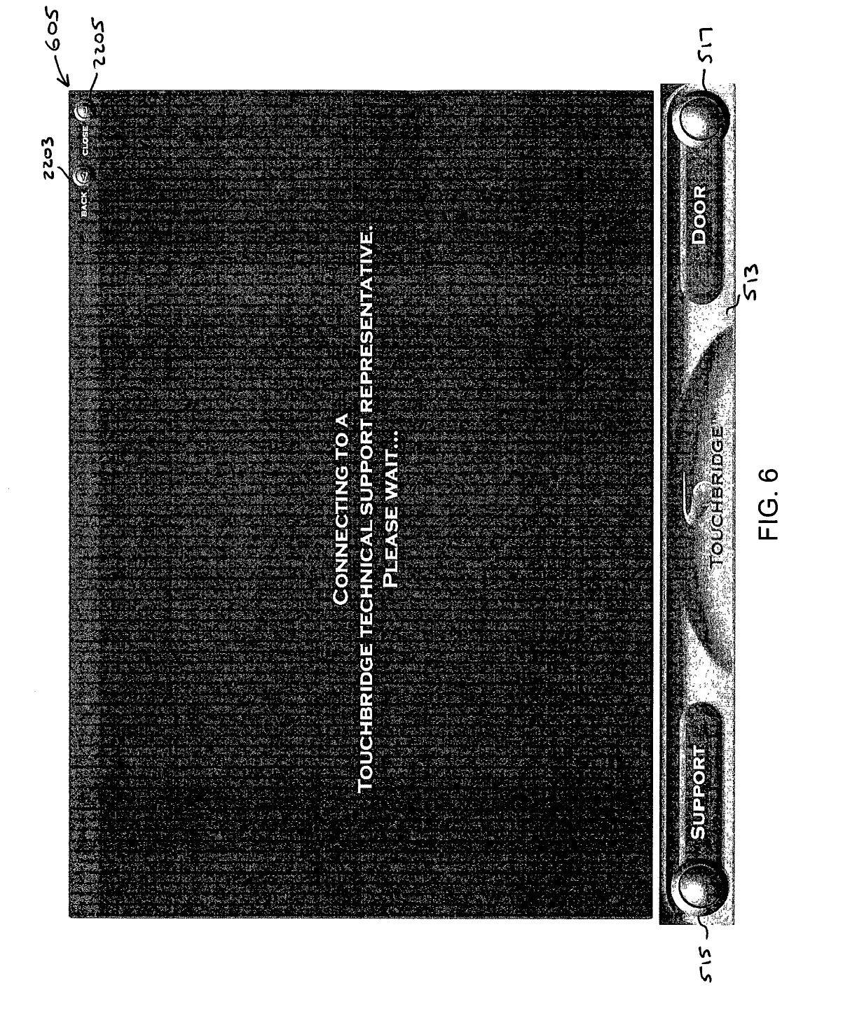

Since quick menu portion 513 is available from initial application launch screen 503, a user who chooses to may easily press technical support application launch icon 515 at any time. FIG. 6 depicts a schematic representation depicting the visual display of a touch screen associated with a distributed user control interface device showing a typical initial technical support screen 605 of the embodiment shown in FIG. 5 after pressing technical support application launch icon 515. In this case, the system allows a connection to a technical support representative, as shown in FIG. 6. The software for starting this technical support representative application is well known in the art, and generally includes e-mail, telephone or text messaging between a customer support representative and the user. Advantageously, the network communication system of the present invention includes video conferencing capabilities allowing the user to enter a video conference with the technical support representative. In any case, the software also provides information to the technical support representative indicative of the status of the network communications system as well as other information which may be useful for resolving a technical support issue, as is well known in the art.

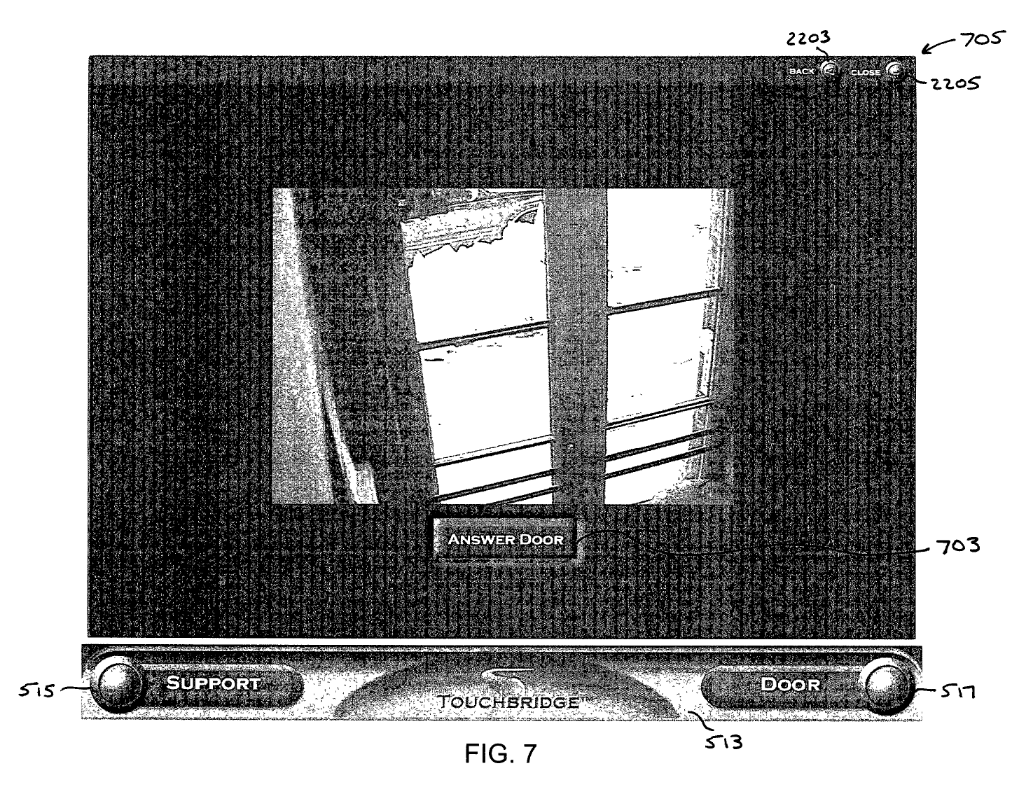

The network communications system is also advantageously connected to a front door intercom and answering application which may be a front door intercom and answering application that is well known in the art. FIG. 7 depicts a schematic representation depicting the visual display of a touch screen associated with a distributed user control interface device showing a typical door answering screen display 705 of the embodiment shown in FIG. 5. When a user presses front door control application launch icon 517 in quick menu portion 513, the software launches the front door application allowing the user to view any activity at the front door (through a video camera mounted to provide such a view), and including an answer door application icon 703 allowing that user to open or permit opening of that front door. In this case, the network communication system will be connected to an electrical or mechanical switch, which when activated by answer door application icon 703 being activated by the user, allows opening of the front door and entry of the visitor. The network communication's system may also be connected to a speaker and a microphone proximate the front door for allowing communication between the user and the visitor at the front door. This will allow the user to interact with the visitor in a manner similar to intercom systems, as is well known in the art.

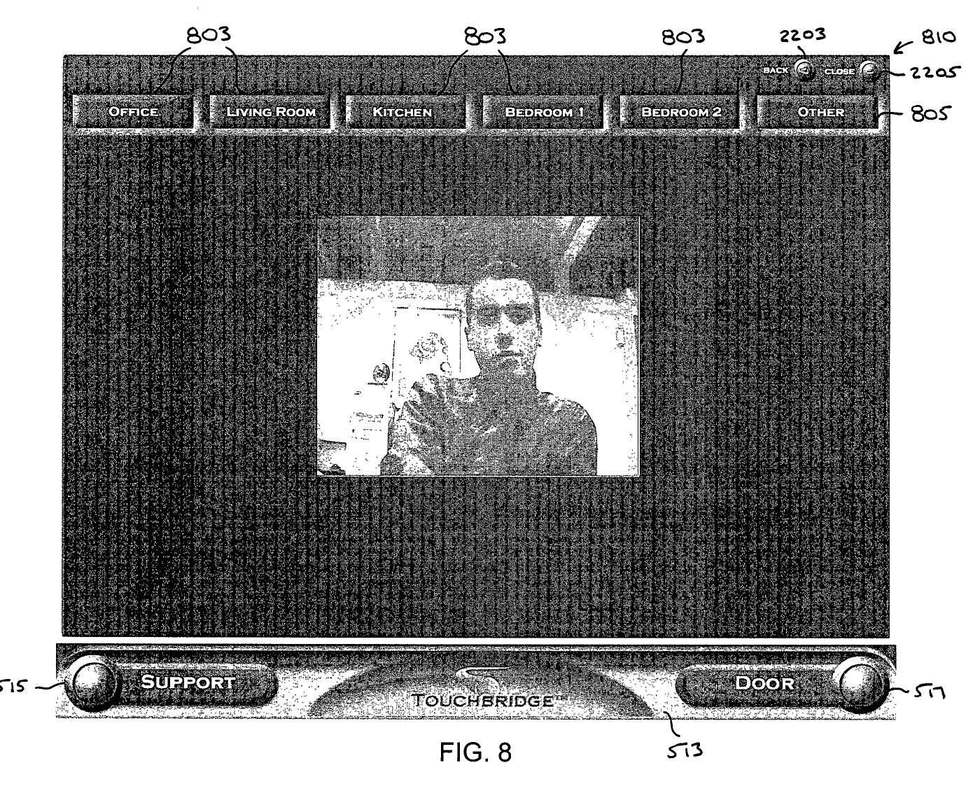

The first one of application launch icons 505 in initial application launch screen 503 in FIG. 5, in this example, includes a video call application launch icon for initializing a video call application. FIG. 8 depicts a schematic representation depicting the visual display of a touch screen associated with a distributed user control interface device showing a typical video calling screen 810 of the embodiment shown in FIG. 5. When application launch icon 505 associated with the video call application is activated, the touch screen display will show a video call application as shown in FIG. 8.

The video call application will generally include local video call control icons 803 for initiating and responding to a video call from known local locations on the data communications network, such as the office, living room, kitchen, bedroom 1 and bedroom 2. Additionally, an outside video call control icon 805 for initiating outside video calls, will allow the user to place a video call to any other person with suitably equipped video conferencing capabilities. Note, calls among users of a centrally connected system may advantageously occur through the networked data communications system itself, and need not involve external telecommunications service providers.

Within the data communications network of the system, the hardware and software is optimized to provide extremely high-grade video imaging and sound quality for video calls. The software also falls back to lower grade video and sound as appropriate to connect with video calling systems that so require, or in the case where bandwidth between the conversing parties is not high enough.

The video camera used advantageously provides a very high frame rate to the video conferencing software, with less CPU overhead, making for a much smoother and natural-looking video experience compared to most other PC-based video conferencing systems. Further, by linking the camera's positioning mechanism to the digital microphone array, the software accurately adjust the camera angle relative to the screen to put the speaker squarely in the center of the frame.

The speaker/microphone combination also allows users to converse in a more natural and comfortable manner, in that unlike most other PC-based video conferencing systems, the video conferencing system of the present invention does not require a headset. The built-in microphone array advantageously provides full-duplex performance, meaning no clipping as the conversation switches between two parties.

Furthermore, noise canceling circuitry, such as those well known in the art, are advantageously used when additional audio signals provided by the system, such as Internet radio, would otherwise create a feedback loop or other distortion.

Video calls made between workstations within a home or office travel over Fast Ethernet connections, resulting in optimum picture and sound quality. On the other hand, video calls made to a workstation outside the home or office travel over the Internet, and generally require a minimum of 384 kbps of bandwidth. Typical wideband Internet connections, such as DSL and cable, can easily be configured to provide at least double that bandwidth to the Internet. Finally, video calls made to those outside the workgroup or family or not connected to the networked data communications system, travel over existing telecommunications services provides networks such as Frame Relay Systems or Plain Old Telephone Systems.

In a preferred embodiment, rather than using a proprietary videoconferencing application developed from the ground up, an existing video conferencing application can be used by advantageously wrapping it with the “look and feel” of the present system's GUI. Like other standardized interface components of the system, the wrapping, or functionality skin, goes well beyond the aesthetic. The wrapper removes seldom-used functions from the given application, making the system much more intuitive, more ‘touchable’ and, ultimately, easier to use on a regular basis.

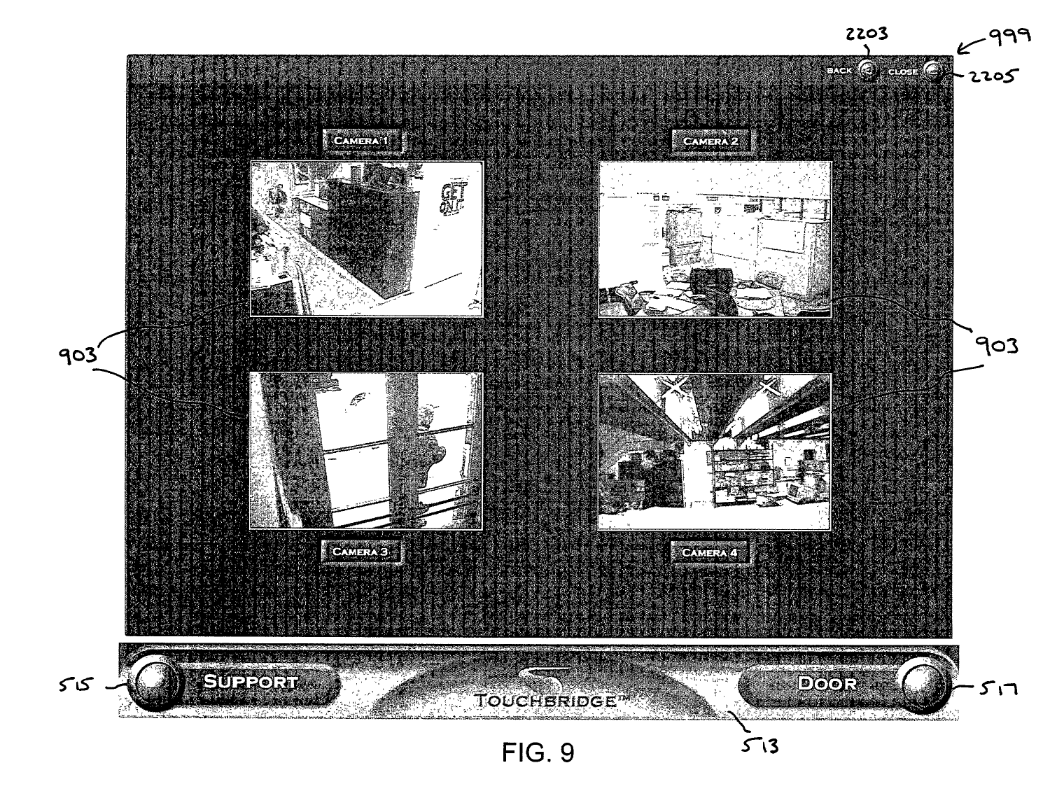

Initial application launch screen 503 also includes an application launch icon 505 allowing the launch of a surveillance application. FIG. 9 depicts a schematic representation depicting the visual display of a touch screen associated with a distributed user control interface device showing a typical surveillance screen 999 of the embodiment shown in FIG. 5. Launching the surveillance application brings up a screen as shown in FIG. 9 having several video camera feed windows 903 providing video camera feeds of areas being watched. Video camera control icons 905, each related to an individual video camera feed window 903, allow the user to control the video cameras to pan and or zoom in ways that are well understood by those of ordinary skill in the art.

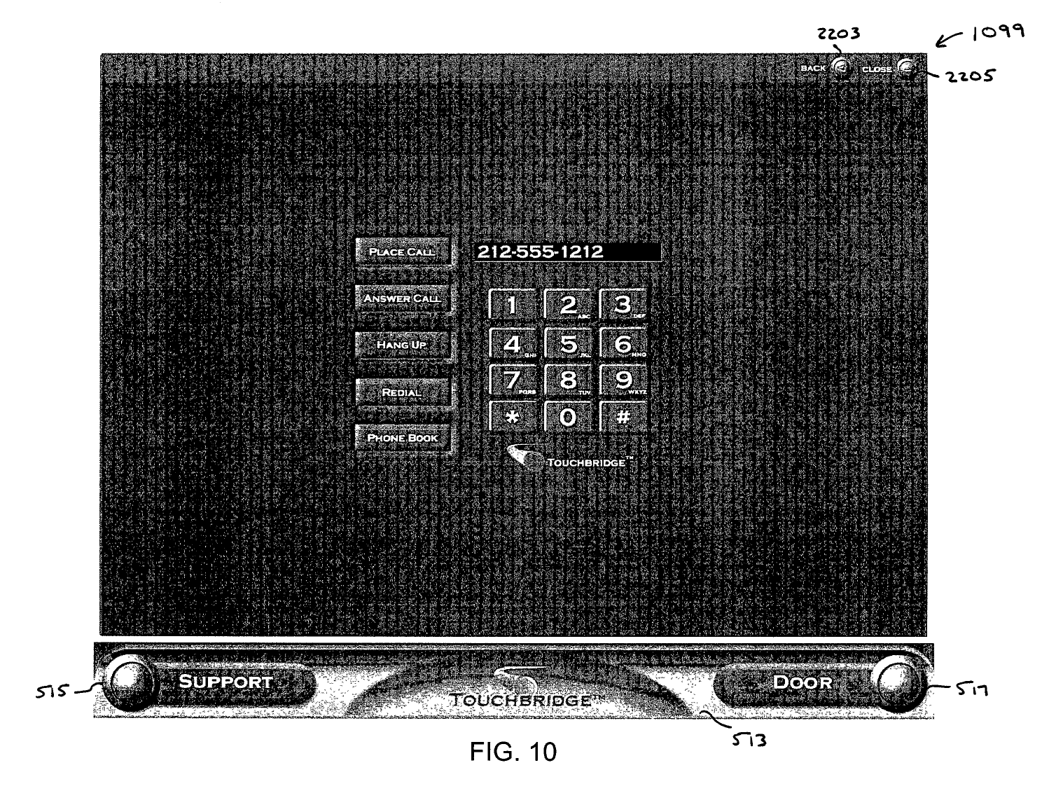

Initial application launch screen 503 also includes an application launch icon 505 for a voice over IP telephone application and can also be connected to a Plain Old Telephone System (POTS). FIG. 10 depicts a schematic representation depicting the visual display of a touch screen associated with a distributed user control interface device showing a typical voice over IP telephony screen of the embodiment shown in FIG. 5. On activating this application, the touch screen display will show the telephone application interface 1099 of FIG. 10. The telephone communications application will allow a user to place telephone calls using voice over IP or conventional telecommunications protocols as appropriate.

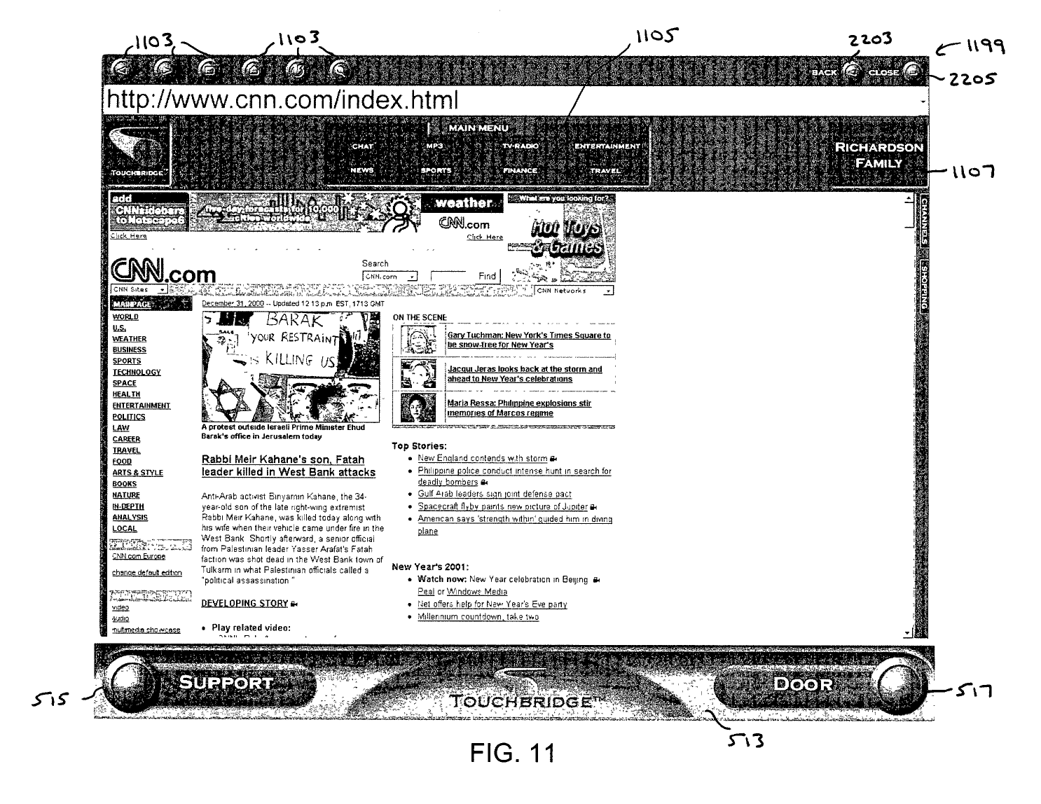

An Internet browser application is also available from initial application launch screen 503. FIG. 11 depicts a schematic representation depicting the visual display of a touch screen associated with a distributed user control interface device showing a typical Internet browser screen of the embodiment shown in FIG. 5. In this case, touch screen 103 displays an Internet browser application as shown in FIG. 11. While the Internet browser application may be based on a standard browser as is well known in the art, additional icons and functions are made available by the networked communication system of the present invention. For example, simplified navigation and browsing buttons 1103 replace the user interface of the underlying program. An Internet application menu bar 1105 includes icons allowing the easy launch of other typical Internet applications, such as a chat application, MP3 player, television and radio viewers, entertainment, news, sports, finance and travel portals, and the like. Additionally, a main personalized content page icon 1107 is connected to the same personalized content pages that are available from personalized page icons 507 in FIG. 5 so that a user may view his or her Internet book marks and customized content as further described herein.

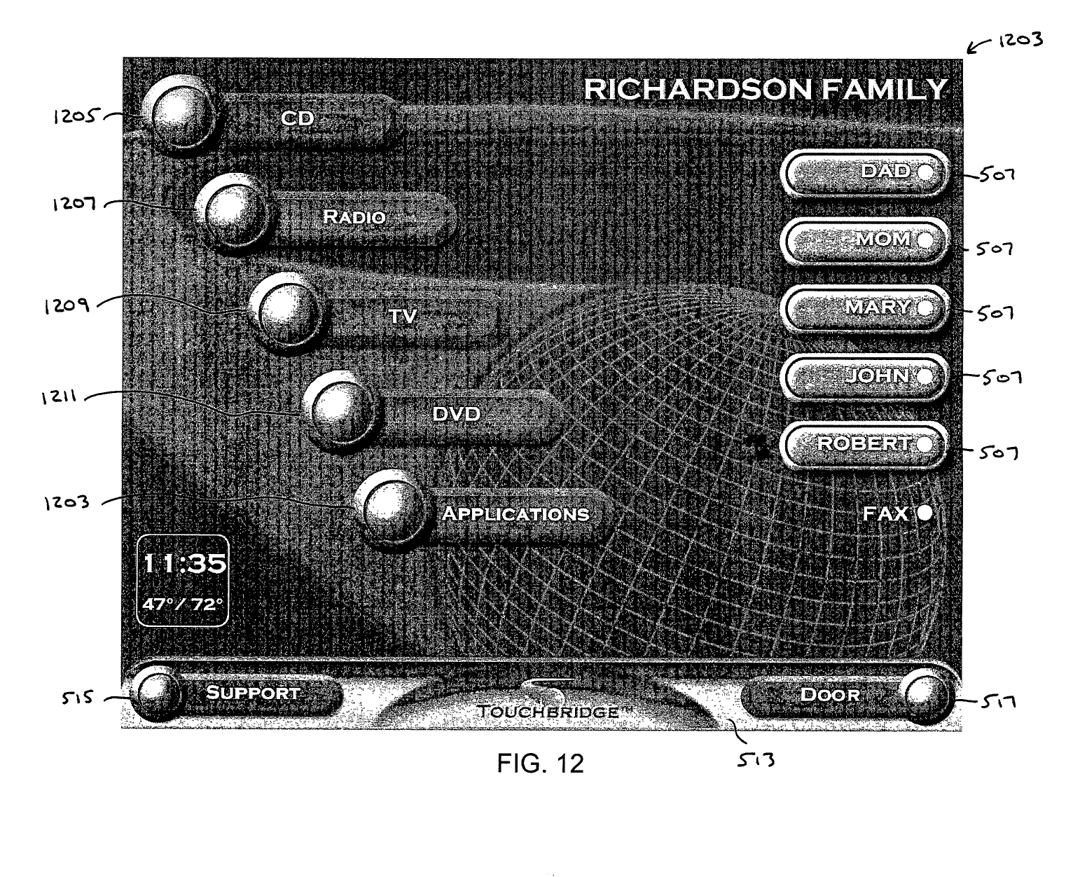

A main multimedia menu icon 505 on initial application launch screen 503 in FIG. 5 launches a multimedia sub menu screen 1203 depicting several multi-media applications. FIG. 12 depicts a schematic representation depicting the visual display of a touch screen associated with a distributed user control interface device showing a typical multimedia sub menu screen of the embodiment shown in FIG. 5.

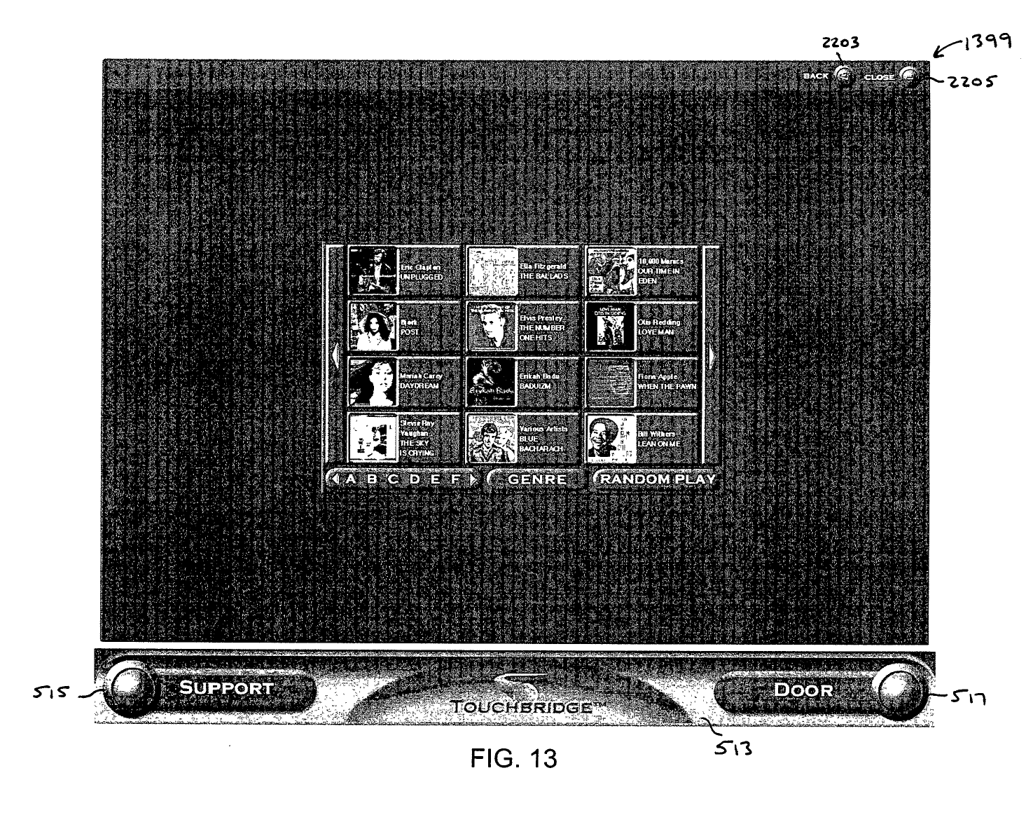

If the user selects the CD application launch button 1205 in the multimedia sub menu screen 1203 in FIG. 12, a CD application is launched. FIG. 13 depicts a schematic representation depicting the visual display of a touch screen associated with a distributed user control interface device showing a typical CD library screen 1399 accessed from the multimedia submenu screen of the embodiment shown in FIG. 12. The CD application advantageously includes images and information about the CDs available (i.e., stored on the hard drive of the server), as well as tools for searching by name, genre and the like, as is well known in the art.

The software in the data communication system is programmed and configured to read a CD jukebox that can be loaded with a user's complete CD collection. The CD tracks are copied from the loaded CDs and stored as MP3 audio files on the network server, en masse. Using an algorithm, the CDs are identified against a licensed database of CD information, and the relevant CD information, including album title, track titles and times, and album cover art, are stored in the server's database. The software in the data communication system is additionally programmed and configured to copy CD tracks from CDs and store them as MP3 audio tracks on the network server whenever a new CD is played in the CD player of any workstation. In this way, the data communications system includes a complete record of the user's CD library,including new CDs as they are acquired, which are thus available from any workstation on the system, including by remote access.

Moreover, the software in the data communications system uses a software algorithm for identifying CDs before storing them as MP3 audio tracks, such algorithm representing an improvement over the prior art. As is standard in the industry, the algorithm makes use of a licensed third-party database which pairs CD titles with track lengths. To identify a particular CD, the algorithm first determines the length of the CD's first track, and then selects from the database the subset of CDs with a first track length differing from this length by no more than seven seconds. This process is then repeated on the subset, except that the length of the CD's second track is compared, and so on, until a single match is found. The seven second differential is provided in order to account for variations in the track lengths between multiple pressings of the same CD title. By contrast, the prior art identifies a CD by attempting to find a record in the database with matching track lengths of all tracks, typically by employing a hash function or the like. Thus, under the prior art, the licensed database must contain a separate record for each pressing of a CD in order for all copies of the CD to be correctly identified. This limitation is removed by the systems proprietary software recognition algorithm which advantageously tolerates variances in the track lengths between multiple pressings of the same CD, thereby allowing a greater number of CDs to be correctly identified.

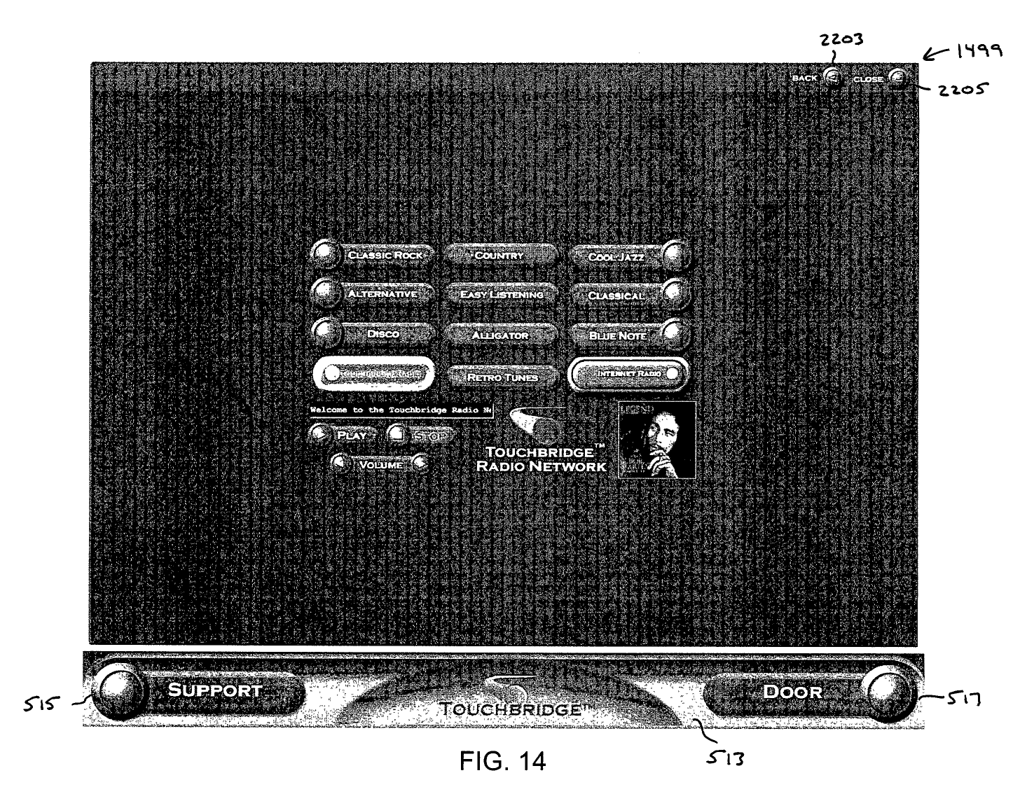

Pressing the radio application launch button 1207 on multimedia sub menu screen 1203 in FIG. 12 launches an Internet radio application. FIG. 14 depicts a schematic representation depicting the visual display of a touch screen associated with a distributed user control interface device showing a typical Internet radio application screen 1499 accessed from the multimedia submenu screen of the embodiment shown in FIG. 12. The Internet radio application may be connected to Internet radio services from any number of network services providers and provides the user with a wide variety of music programming, as is well-known in the art.

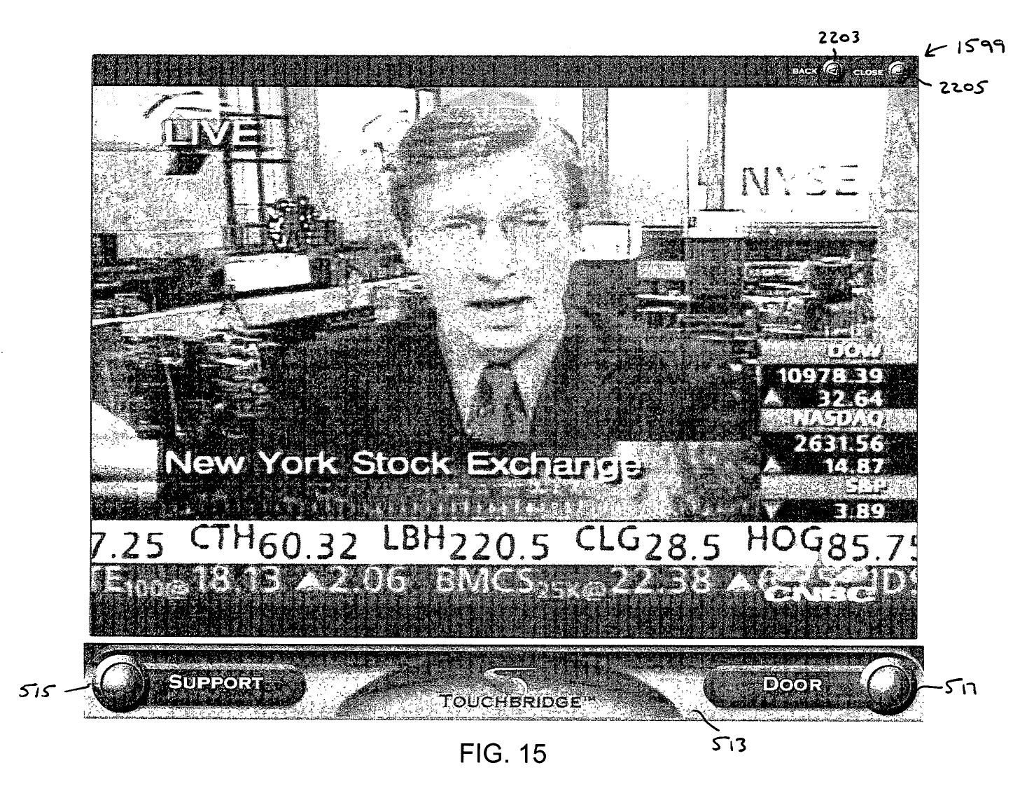

Selecting the TV application launch button 1209 on multimedia sub menu screen 1203 in FIG. 12 opens a streaming video television application. FIG. 15 depicts a schematic representation depicting the visual display of a touch screen associated with a distributed user control interface device showing a typical streaming video television screen 1599 accessed from the multimedia submenu screen of the embodiment shown in FIG. 12.

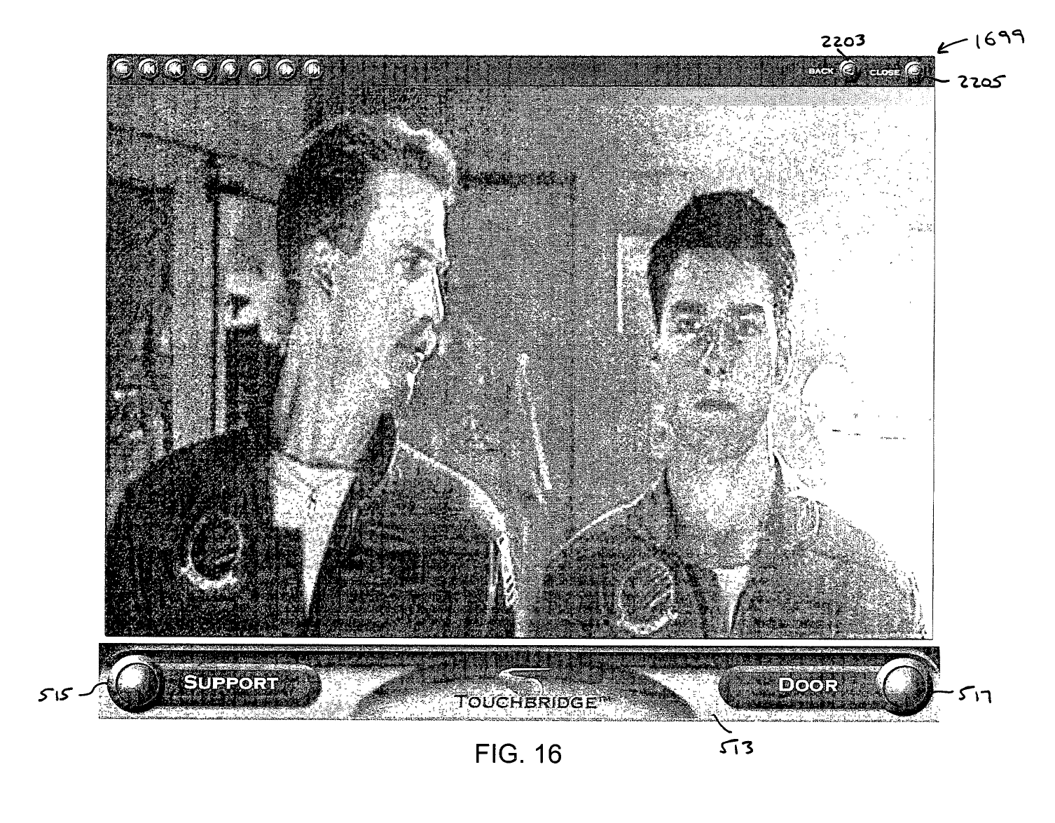

Pressing the DVD application launch button 1211 on multimedia sub menu screen 1203 in FIG. 12 opens up a streaming video DVD application. FIG. 16 depicts a schematic representation depicting the visual display of a touch screen associated with a distributed user control interface device showing a typical streaming video DVD screen 1699 accessed from the multimedia submenu screen of the embodiment shown in FIG. 12.

For applications that make use of streaming video, such as the TV application and the DVD application, the software also provides functionality for transferring, or “flinging” the video and audio from the distributed user control interface touch screen to any other video screen connected to the network communications system, such as the home television screen or high-definition video monitor or plasma display. In this case, the network communications system executes a macro or other software program for starting and controlling the other video screen and home audio video components and transferring the video feed thereto.

When using the touch screen user interface, a user may “fling” streaming audio and video to an external device by pressing a button or dragging a finger across the touch screen. In this way, the user experience is enhanced as streaming video television and DVD feeds may be effortless transferred for view on larger devices such as a home television screen.

Finally, pressing the main menu application launch button 1213 on the multimedia sub menu screen 1203 in FIG. 12 will return the user back to initial application launch screen 503 shown in FIG. 5.

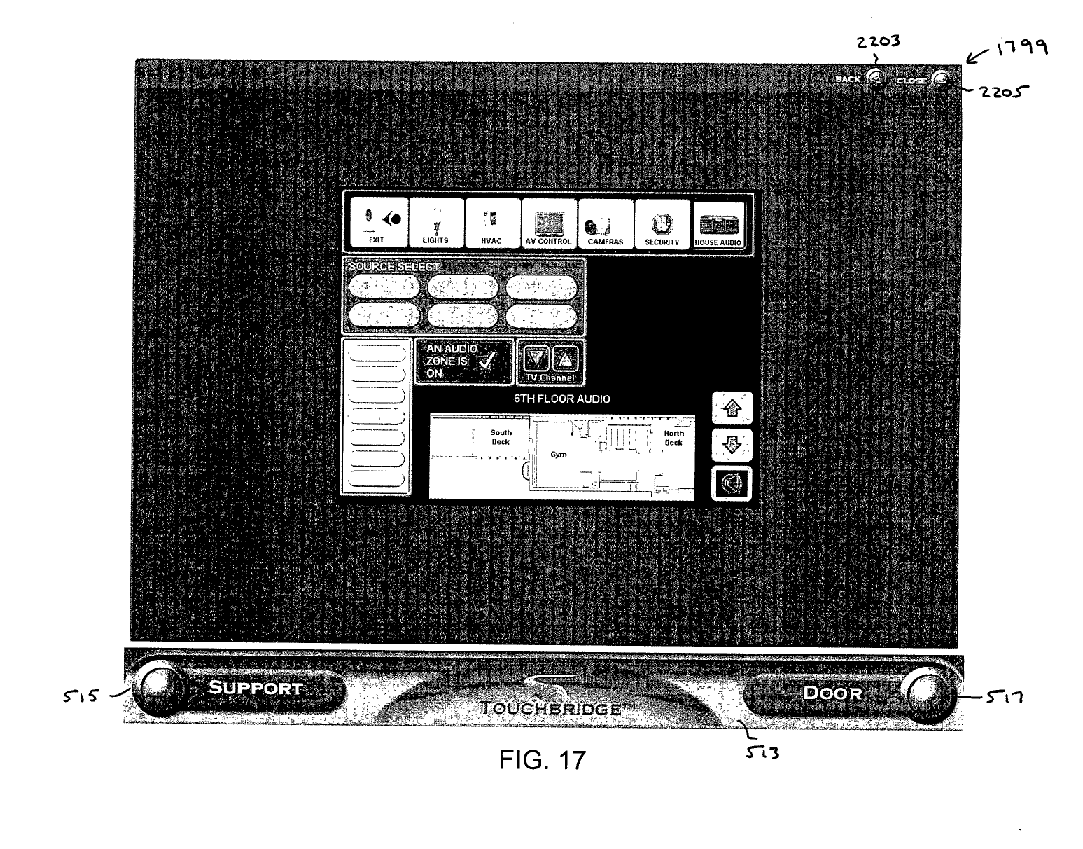

If the user selects the home environment control application launch button 505 on initial application launch screen 503, a home environment control application is launched. FIG. 17 depicts a schematic representation depicting the visual display of a touch screen associated with a distributed user control interface device showing a typical home automation environmental control screen 1799 of the embodiment shown in FIG. 5. The home environment control application may be any of the well known environmental control applications available for home automation networking. These applications typically include controls for lighting in a home, heating, ventilation and air conditioning (HVAC), typically including the ability to heat or cool several zones in a home to different temperatures, audio visual controls for the home audio and video systems, and home security functions.

The software includes many features intended to make operations simple and straightforward. While many computer applications allow customizations for a given user, these customizations are generally hard to manage and many people do not take advantage of these features. By contrast, the network communications system of the present invention easily manages customizations for each user. Typically, each user will have their own settings, as described further below.

The user may choose to enter his or her personalized area within the network communications system by selecting personalized page icon 507 associated with his or her name in FIG. 5. For example, the user, Robert, may select a personalized page icon 507 having as its indicia the name “Robert” 521. Personalized page icons 507 associated with each member of a workgroup or family thus permit each member to easily enter their personalized application launch screen, as described further below. FIG. 5 also shows iconic indicia 523 which may indicate, for example, the presence of e-mail messages or voice mail messages for a given workgroup member or family member.

Advantageously, the software is triggered to log out a current user and log in a new user merely by the new user activating fingerprint reader 111.

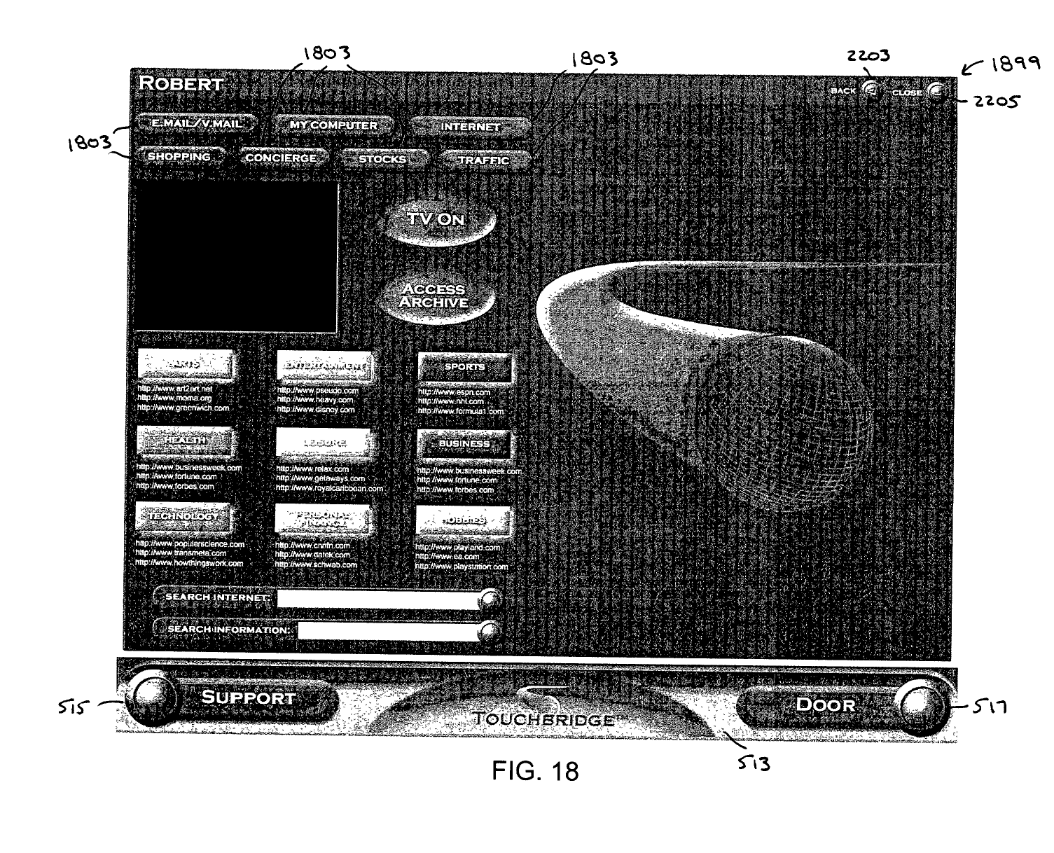

FIG. 18 depicts a schematic representation depicting the visual display of a touch screen associated with a distributed user control interface device showing a typical user personalized application launch screen 1899 of the embodiment shown in FIG. 5. The personal preferences application of FIG. 18 includes personal application icons 1803 allowing the user to launch common applications that may be personal to him or her, such as an e-mail program. FIG. 19 depicts a schematic representation depicting the visual display of a touch screen associated with a distributed user control interface device showing a typical e-mail application window 1999 on the user application launch screen 1899 of the embodiment shown in FIG. 18. Note, upon the running of a second application, namely the e-mail application of FIG. 19, the touch screen shows both applications on the touch screen panel at the same time. In this way, the user's personal preferences application is available, as well as the e-mail application.

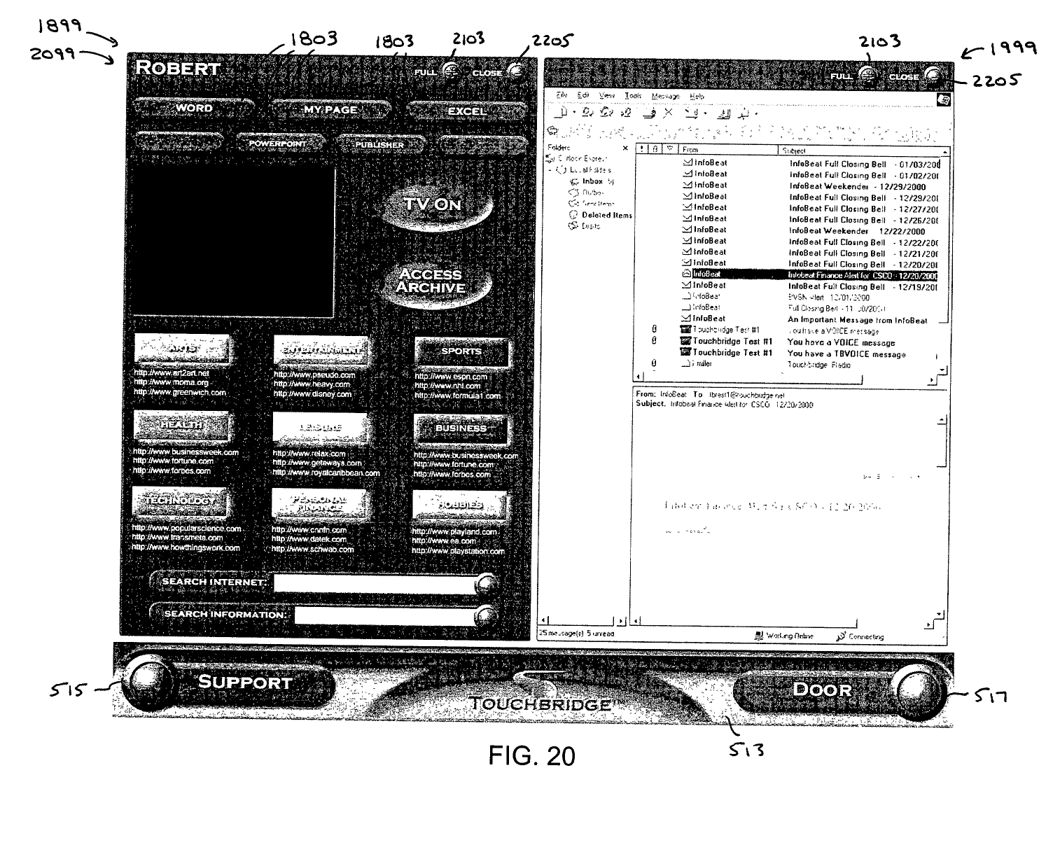

Selecting the “my computer” button 1803 in FIG. 19 opens up a computer application sub menu. FIG. 20 depicts a schematic representation depicting the visual display of a touch screen associated with a distributed user control interface device showing a typical computer application launch screen 2099 on the user application launch screen 1899 of the embodiment shown in FIG. 19, allowing the user to launch and run computer applications such as Microsoft Word, Microsoft Excel, and the like.

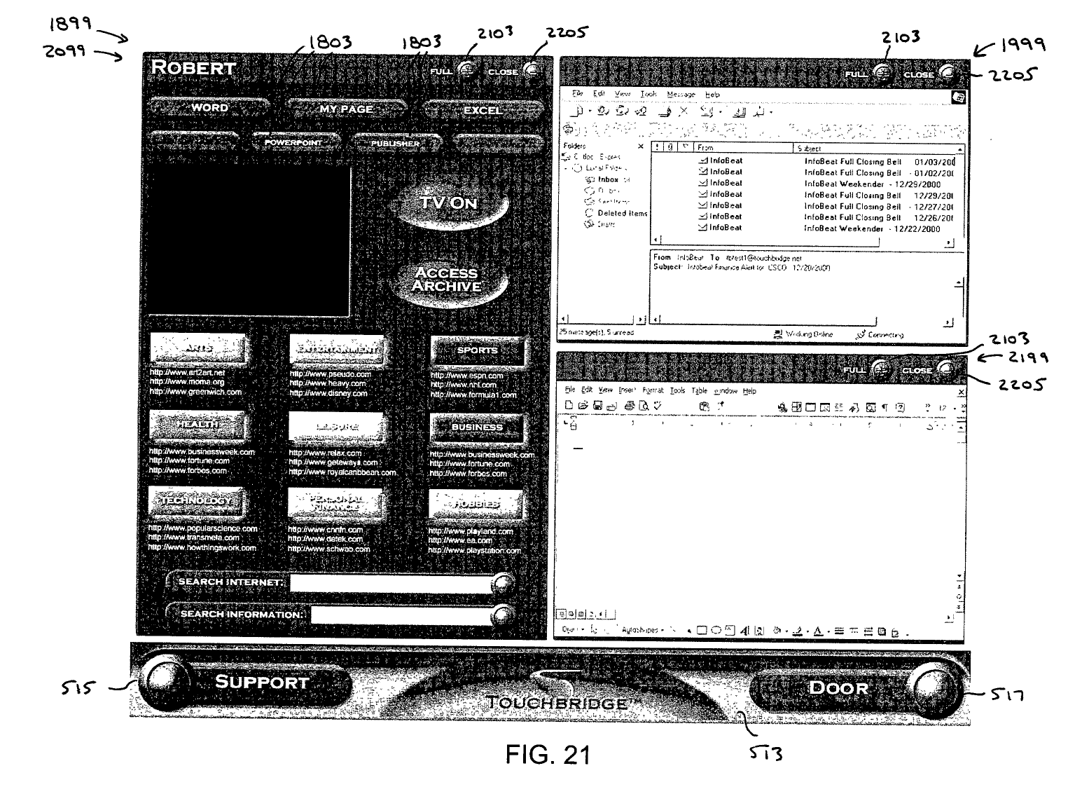

FIG. 21 depicts a schematic representation depicting the visual display of a touch screen associated with a distributed user control interface device showing a typical word processing application window 2199 on the user application launch screen 1899 of the embodiment shown in FIG. 19 and shows Microsoft Word being run in a window (2199) on touch screen 103. In this case, since the user selected the Word application, this application comes up in a new window. Advantageously, the existing running applications are not shut down or blocked from view by this new application. In this way, the user has continuing access to his personal preferences application, and his e-mail application while running Microsoft Word.

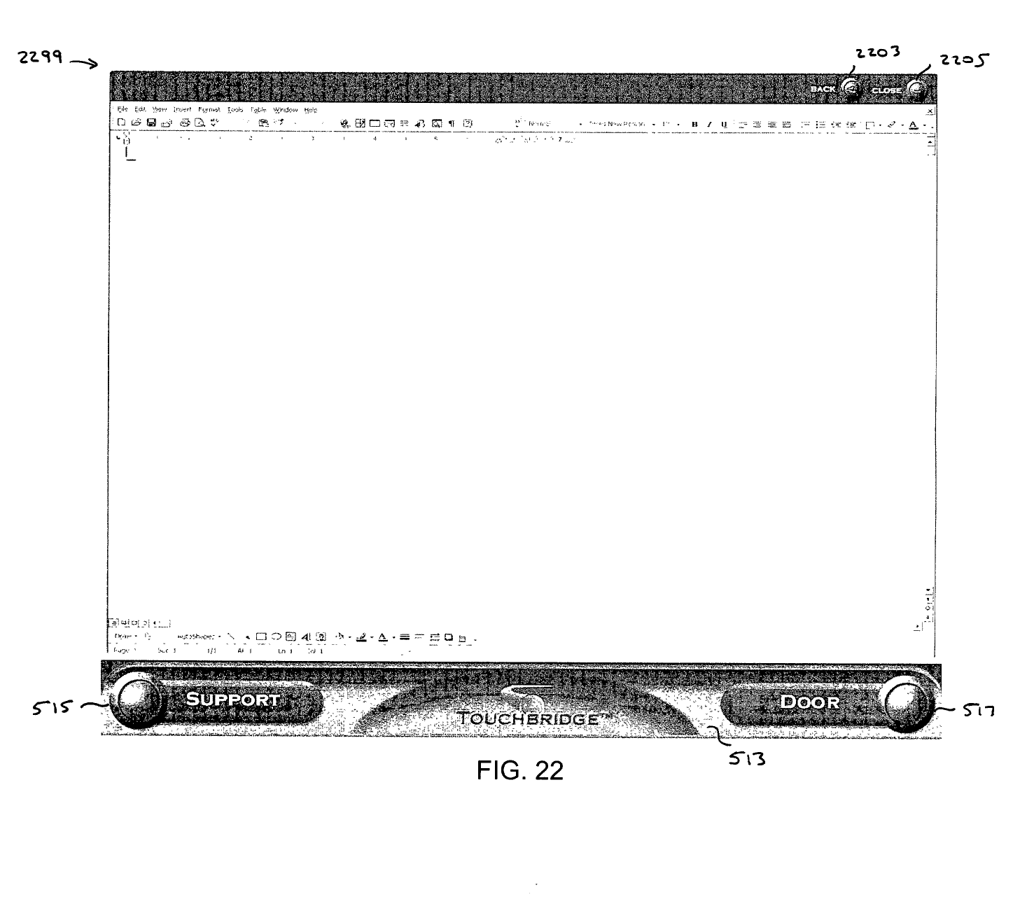

Standardized full icons 2103 in any window, for example within the Word window of FIG. 21, allow the user to launch any particular running application as a full screen application. FIG. 22 depicts a schematic representation depicting the visual display of a touch screen associated with a distributed user control interface device showing a typical word processing application 2299 in a full screen window of the embodiment shown in FIG. 5. In this manner, the user can interact with the software application in a standard way.

When applications are running in a full screen, they will typically also include a standardized back icon 2203, which when activated, restores the application to its windowed state as in FIG. 21 (all three applications being displayed). Alternatively, when done with the application, the user can activate a standardized close icon 2205 to shut down the application. In this case, the display returns to the windowed state as in FIG. 20 (only two applications running).

FIG. 23 depicts a schematic representation depicting the visual display of a touch screen associated with a distributed user control interface device showing a typical Internet browsing application window 2399 on the user application launch screen 1899 of the embodiment shown in FIG. 19 along with the e-mail application 1999 and the personal preferences application.

Simplified Web browsing is provided for among pre-defined categories of Web content. A list of topic categories 2305 selected based on a hierarchy of user preferences is displayed. The user may cycle through URLs of interest 2307 in particular categories. URL results 2309 may be discarded or book-marked [archived] into the presently selected categories or into subcategories, based on the current category viewed, using standard buttons, for future access.

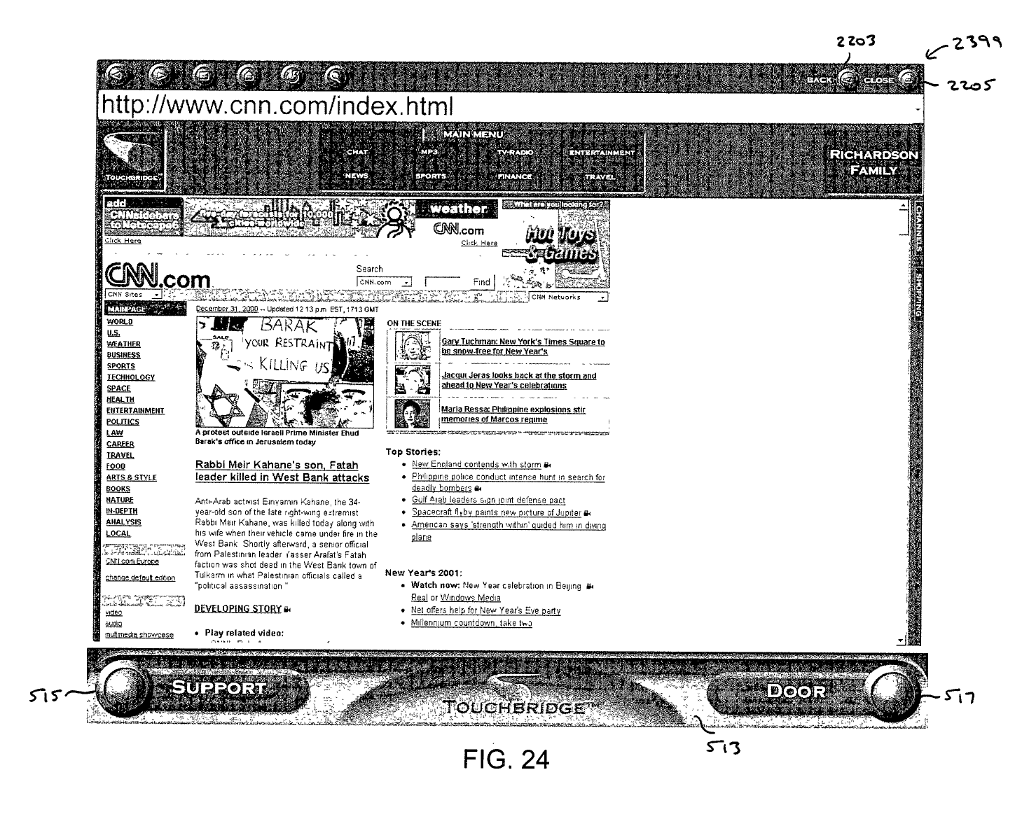

FIG. 24 depicts a schematic representation depicting the visual display of a touch screen associated with a distributed user control interface device showing a typical Internet browsing application 2399 in a full window of the embodiment shown in FIG. 5, which is identical in appearance to running the Internet application from the initial application launch screen 503 in FIG. 5 but for the new user's personalization's and preferences. See, for example FIG. 11. The new user's personalized settings, such as bookmarks and the like, will be available, as is known in the art.

FIG. 25 depicts a schematic representation depicting the visual display of a touch screen associated with a distributed user control interface device showing a typical door answering application window 2599 of the embodiment shown in FIG. 23 launched from quick menu portion 513, which is also available on the user customization application. Now, four (4) applications are running, each in a separate window of the display.

FIG. 26 depicts a schematic representation depicting the visual display of a touch screen associated with a distributed user control interface device showing a typical quick menu window of the embodiment shown in FIG. 23 after the user has selected the quick menu activation icon 523 (See also FIG. 5). In this case, quick menu portion 513 expands allowing access to additional quick menu items. For example, the user may select the telephone application from the quick menu.

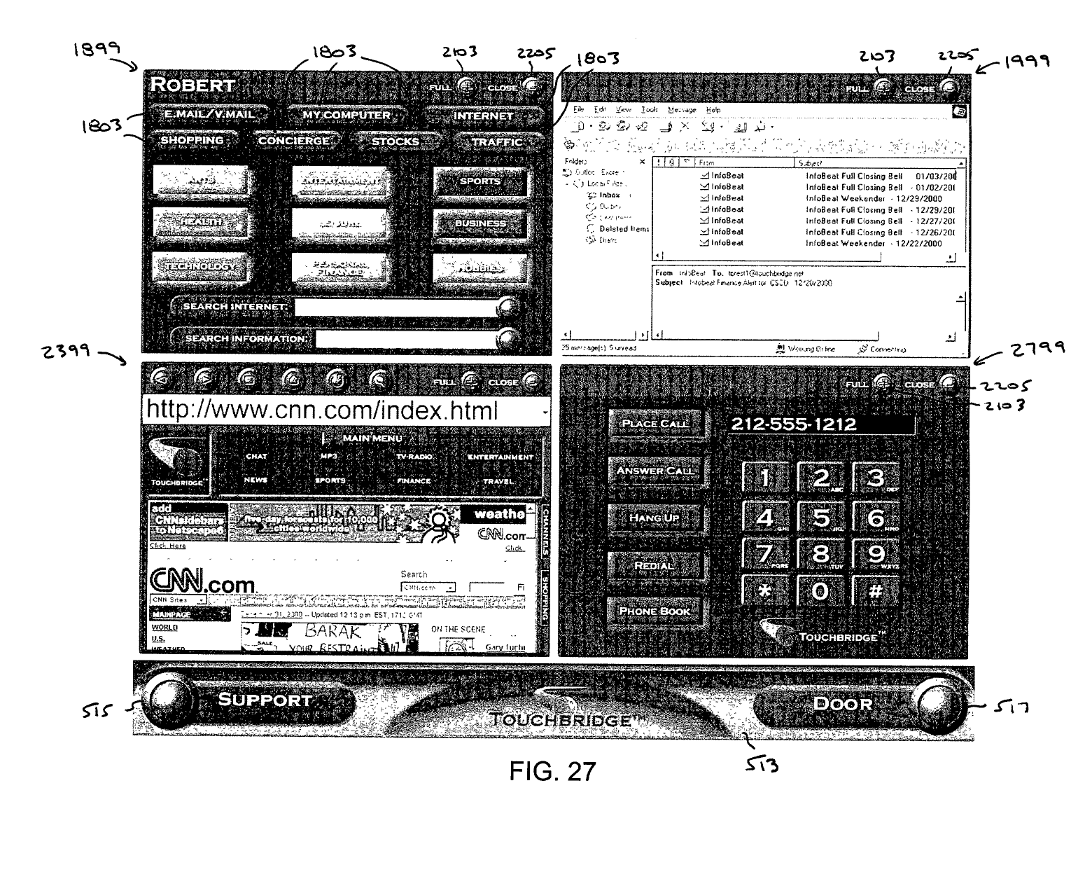

FIG. 27 depicts a schematic representation depicting the visual display of a touch screen associated with a distributed user control interface device showing a typical voice over IP telephone application window 2799 of the embodiment shown in FIG. 26. In this case, quick menu portion 513 retracts and the telephone application becomes the fourth application being run, allowing the user to place a telephone call.

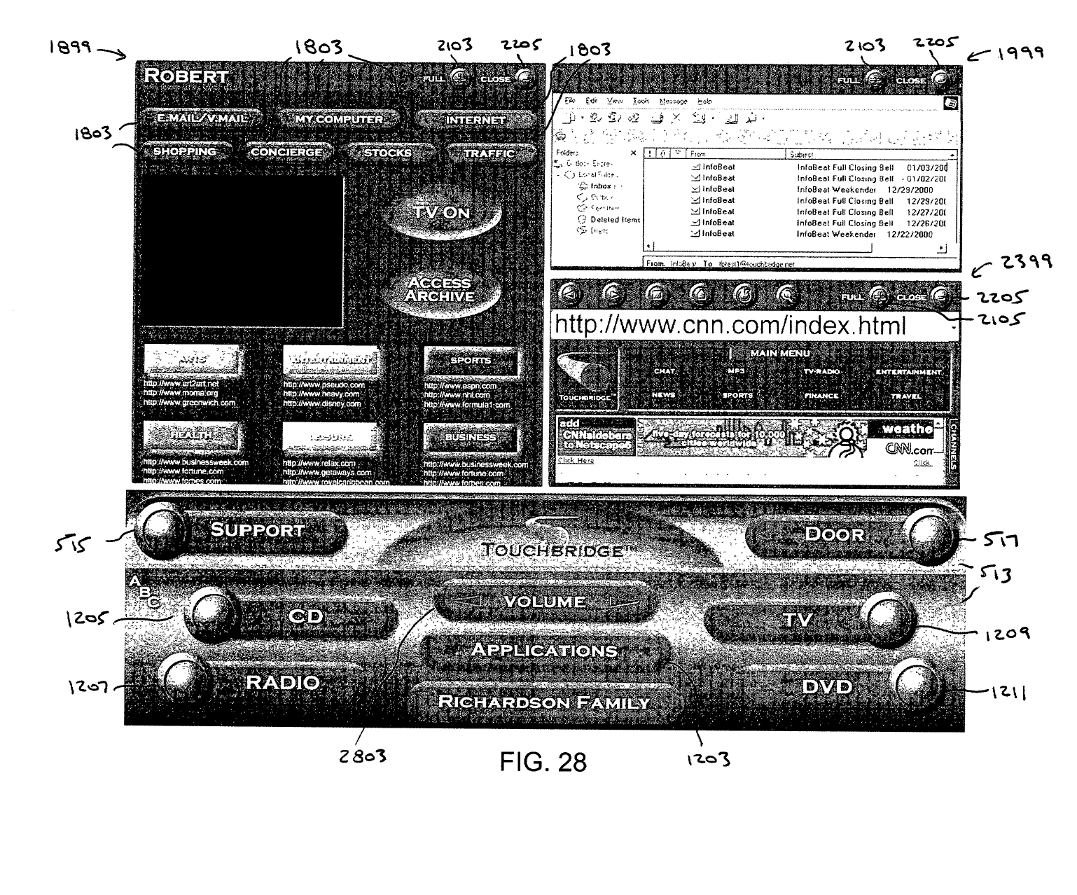

FIG. 28 shows the expanded quick menu portion 513 after activating the multimedia sub menu icon 505 in FIG. 26. Note, easy access to the volume bar control area 2803 allowing easy access to control of the volume of any multimedia applications that are currently being run.

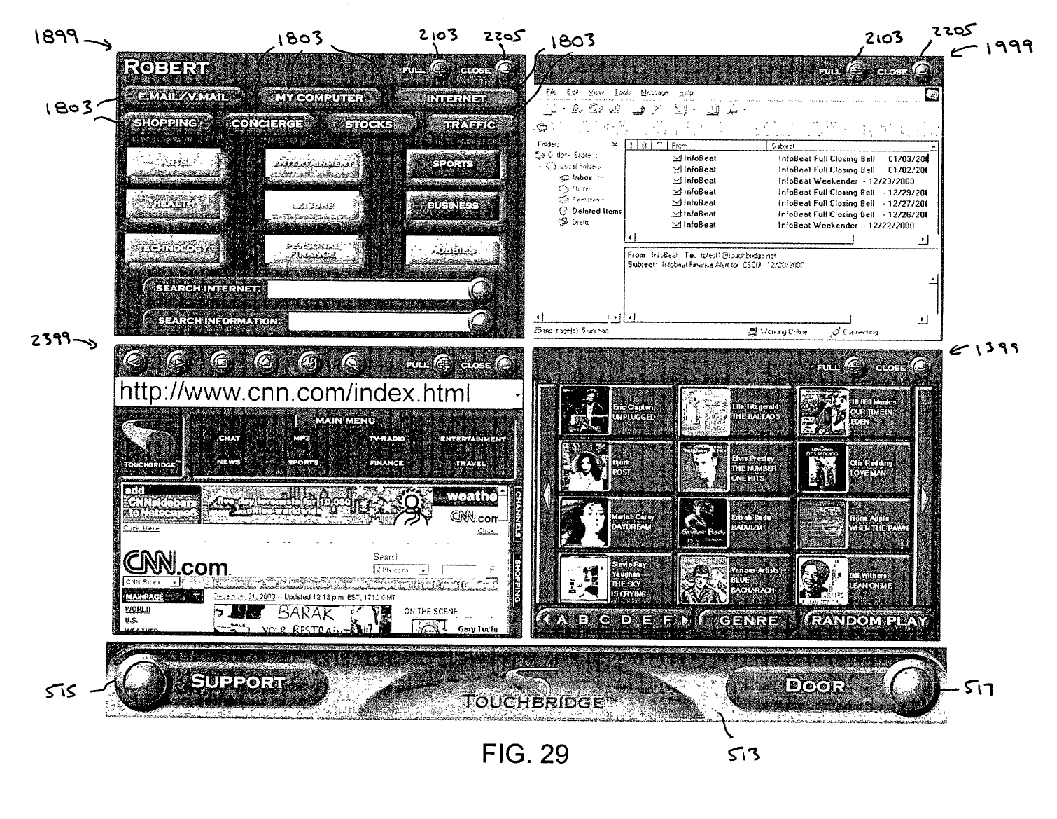

FIG. 29 depicts a schematic representation depicting the visual display of a touch screen associated with a distributed user control interface device showing a typical CD jukebox application window of the multimedia submenu window of the embodiment shown in FIG. 28 selected from the quick menu multi media sub menu 505, along with the Internet application, the e-mail application and the user customization application.

It is noted that the personalized page icons 507 are available on initial application launch screen 503 and on multimedia submenu screen 1203. The individual names, for example “Robert” 521, are also used in a submenu accessed by activating a workgroup name icon, such as main personalized content page icon 1107 in FIG. 11, and main personalized content page icon 2605 in FIG. 26.

As described herein, the menu hierarchy provides for simple and straightforward access to applications and content. Furthermore, the user interface manages the display of applications in a convenient and intuitive way. Simplified controls are provided for displaying an application as a full screen, restoring it back to its windowed state, and closing the application.

Those of ordinary skill in the art will easily recognize that the exemplary menu hierarchy described is but one example of an easy to use interface. The distributed user control interface is made even easier to use by maintaining standard button sizes and shapes, along with their relative position on the screen. Additionally, upon activating submenus, existing buttons merely change their indicia, or toggle to a new state.

An exemplary menu hierarchy of a preferred embodiment includes:

Main Interface Buttons

The main interface will include the following buttons: (When pressed they turn a different color to provide positive feedback that the event was recognized)

1. Support

2. Answer Front Door

3. Telephone

4. Surveillance

5. Internet

6. Multimedia

7. Video Call

8. Environment

9. Workgroup/Family members

10. Workgroup/Family Name

11. Workgroup/Family Member buttons

12. Fax

13. Email notification ICON for workgroup/Family Member

14. Vmail notification ICON for workgroup/Family Member

15. Activation icon for personalized content notification

16. Temperature Inside Premise—Display Only

17. Temperature Outside Premise—Display Only

18. Local Time—Display Only

The buttons that will toggle from the main interface include:

Multimedia when selected:

1. Video Call turns into CD

2. Surveillance Turns into DVD

3. Telephone turns into Radio

4. Internet turns into VOD

5. Environment disappears

6. All other buttons remain

Environment when selected:

1. Video Call turns into Temperature

2. Surveillance turns into Electricity

3. Telephone turns into Security

4. Internet Disappears

5. Multimedia Disappears

6. All other buttons remain

The quick access Submenu will include the following buttons to be viewed on initial access:

1. Technical Support

2. Answer Front Door

3. Telephone

4. Surveillance

5. Internet

6. Multimedia

7. Video Call

8. Environment

9. Workgroup/Family members

The buttons that will toggle from the submenu include:

Multimedia when selected:

1. Telephone turns to CD

2. Multimedia turns to Radio

3. Surveillance turns to Volume with Mute in middle of button

4. Environment turns to Applications

5. Internet turns to TV

6. Video Call turns to DVD

7. Workgroup/Family turns to Video on Demand (VOD)

8. Technical Support remains

9. Answer Door remains

Workgroup/Family when selected:

1. Telephone turns to workgroup/Family Member

2. Multimedia turns to workgroup/Family Member

3. Surveillance turns to workgroup/Family member

4. Environment turns to workgroup/Family member

5. Internet turns into workgroup/Family member

6. Video Call turns to Family member if needed

7. Workgroup/family turns to Applications

8. Technical Support remains

9. Answer front door remains

Environment when selected:

1. Telephone turns to Temperature Control

2. Multimedia turns to Electricity Control

3. Internet turns to Security

4. Surveillance remains

5. Environment remains

6. Workgroup/family remains

7. Technical support remains

8. Answer front door remains

9. Internet disappears

10. Video Call disappears

In this way, a simplified and standardized user experience is accomplished with a minimum of designed elements. Each menu or submenu behaves in a consistent manner allowing even novice users to operate computer applications and attached devices.

Thus, the networked communications system and distributed user control interface described allows fingertip management of myriad communication, information, and entertainment applications, and includes high-speed Internet access for delivery of personalized content. The hardware and software provide a turnkey enterprise-strength platform.

The system described typically features flat-panel touch screen displays and an elegant GUI (Graphical User Interface) designed to operate intuitively for non-computer users. Even the most sophisticated tasks can be accomplished with just a few touches of the on-screen buttons. The touch screen mounts on its supplied pedestal stand or on a wall, and can instantly be transferred from one location to the other.

Each distributed user control interface in a home or office comprises a touch screen and a fully equipped PC workstation. The stations are connected to each other and to the Router and Main Server via 100 Mbps Fast Ethernet. The Main Server links to the outside world—and to network services providers—via a Symmetrical DSL connection.

Built into each touch screen housing are a video camera, a microphone array, stereo speakers, and a biometric thumbprint scanner that acts as a guard for each user's personal information. In addition, the mounting base contains a subwoofer (a speaker dedicated to low frequencies).

Applications provided with the system typically include: high-speed Internet access; personal web pages and messaging center; e-mail; voice mail; Internet telephone; video conferencing; video surveillance; and a hard drive-based CD jukebox.

Each system is capable of easily running and displaying at least four applications simultaneously, including DVD-quality audio and video. The system can also be “overlaid” onto or interface with existing home automation control systems (such as those for lighting, climate, security, and entertainment systems), allowing it to serve as complete home controller as well.

Through a network of services partners and affiliates, the system can be linked to a variety of free services as well as premium services available to those who choose to subscribe, ranging from customized Internet radio to real-time traffic feeds to a personal concierge services.

As minimally configured, the system typically comprises three stations, each with a fully equipped PC workstation and a flat-panel touch screen. The network can support as many as 16 or more additional workstations. All of the PCs are interconnected by Ethernet cable, which in turn connects to a Router and then to the Main Server. (In IT parlance, this is known as a Star configuration.)

The Main Server also links to the outside world—and to the various network services providers—via a Symmetrical DSL connection. Symmetrical DSL operates at 768 kbps for downloading and uploading. The router allows for at least six simultaneous Internet connections.

Among other functions, a network services provider can provide remote diagnostics associated with 24/7/365 Live Customer Support.

Every workstation is capable of running and displaying at least four applications simultaneously, including DVD-quality audio and video. This is made possible by the networking software as well as the 100 Mbps Fast Ethernet throughput. By contrast, a typical home network operates at no more than 11 Mbps throughput.

Once a user has been cleared for access by a workstation's built-in biometric thumbprint scanner (or by conventional login), that user's personalized world of information, communication, and entertainment applications is available by just touching the screen. All applications on the system advantageously may also be accessed by voice command, or by typing commands on the wireless keyboard.

For example, a touch on the screen places a video call to the user's sister in Seattle. When calling another workstation—inside or outside the location of the server—the video images are as fluid as television. The workstation's built-in camera, speakers, and duplexing microphone array with noise and echo cancellation allow the user to converse comfortably, as if he or she were really sitting face-to-face.

Advantageously, the networking software also includes predefined logic for managing device interrupts over the system. For example, when the front door chimes. In this case, a touch on the screen opens a view from the front door camera and interrupts any audio or video feeds with the audio and video feeds from the front door intercom and answering application.

As a user listens to his or her CDs on the workstation's built-in DVD/CD player, they are automatically “ripped” to the main server and added to the digital jukebox. At a touch of another button, the user can switch playback of the audio from the workstation's built-in speakers to external speakers connected to a separate audio system. When a phone call is received the networking software's device managing heuristic again comes into play as the music is interrupted and replaced or overlaid with the sound of a ringing phone.

Simultaneously, another user can be using another workstation to type into a word processing application in one window of his or her touch screen, while browsing the Internet in another, checking e-mail in a third, and watching a satellite movie in a fourth. When he or she is done working, the user can touch the screen and instantly fling the movie from its own window on the touch screen to the larger TV monitor in the room connected to the existing satellite receiver.

At the same time, another user, engaged in a video conference call, leaves his workstation and is tracked by his workstation's video camera until he enters the next room, and is picked up the video camera positioned there, all the while remaining visible on the call.

Simultaneously, yet another user can be working on a spreadsheet application in full screen mode while listening to his or her favorite Internet radio station running as a background application. The user could switch the audio playback sound to the room's existing audio speakers, but rather enjoys hearing it through the display's built-in, high-quality speakers and subwoofer while typing on the wireless keyboard. Before the last user retires for the night, he or she can touch the screen to turn off the downstairs lights and activate the security system.

The system thus described provides a flexible and easily adaptable platform with complete hardware and software compatibility. It is designed for turnkey installation and integrates all communication, information, and entertainment functions in a home or office environment.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

What is claimed is:

1. A distributed user control interface for a network, comprising:
logging means for at least one of logging on and logging off the network based on user biometrics.

2. The distributed user control interface of claim 1, wherein said logging means at least one of logs on and logs off the network without restarting an operating system associated with the network and without involvement of a profile manager associated with the network.

3. The distributed user control interface of claim 1, wherein said logging means comprises a fingerprint reader for authenticating individual users based on fingerprints.

4. The distributed user control interface of claim 1, further comprising accessing means for automatically accessing individual user accounts in response to an output of said logging means.

5. The distributed user control interface of claim 1, further comprising display means for displaying video data to an individual user in accordance with previously stored customized display settings and preferences corresponding to the individual user.

6. The distributed user control interface of claim 5, further comprising storing means for storing the customized display settings and preferences.
